(19) United States
(12) Patent Application Publication
(10) Pub. No.: US 2025/0182084 A1
(43) Pub. Date: Jun. 5, 2025

(54) AUGMENTED REALITY DATA CAPTURE AID

(71) Applicant: Capital One Services, LLC, McLean, VA (US)

(72) Inventors: Keegan FRANKLIN, Tucson, AZ (US); Aeman JAMALI, Indianapolis, IN (US); Jordan ARRIETA, Wilmington, DE (US); Megan OBRIEN, New Orleans, LA (US); Danielle WEGRZYN, Bear, DE (US); Michael CROGHAN, Herndon, VA (US); Kai SI, Monterey Park, CA (US); Sasha AHRESTANI, Philadelphia, PA (US)

(73) Assignee: Capital One Services, LLC, McLean, VA (US)

(21) Appl. No.: 18/529,623

(22) Filed: Dec. 5, 2023

(51) Int. Cl. G06Q 20/32; G06Q 20/04

(52) U.S. Cl. CPC G06Q 20/3223; G06Q 20/042

(57) ABSTRACT

A computer implemented method, system, and non-transitory computer-readable device for a remote deposit environment. The method may include using a mobile device to identify a substantially level surface within a field of view of a camera of the mobile device; display an image stream of a physical environment including the substantially level surface and a virtual model of a financial instrument, the virtual model of the financial instrument depicted as having a position and orientation relative to the substantially level surface; instruct a user to position a financial instrument such that the financial instrument is aligned with the virtual model; determine a distance from the mobile device to the financial instrument and an orientation of the mobile device relative to at least one of the financial instrument or the substantially level surface; and based on the distance and the orientation of the mobile device, automatically capture an image.

### BACKGROUND

As financial technology evolves, banks, credit unions and other financial institutions have found ways to make online banking and digital money management more convenient for customers. Mobile banking apps may let you check account balances and transfer money from your mobile device. In addition, a customer may deposit paper checks from virtually anywhere using their smartphone or tablet. However, customers need to take images with, for example, a scanner of the check to have them processed remotely.

### BRIEF DESCRIPTION OF THE DRAWINGS

The accompanying drawings are incorporated herein and form a part of the specification.

FIG. 1 illustrates an example remote deposit check capture, according to some embodiments and aspects.

FIG. 2 illustrates example identifiable check fields, according to some embodiments and aspects.

FIG. 3 illustrates a block diagram of a remote deposit system architecture, according to some embodiments and aspects.

FIG. 4 illustrates an example state diagram of a remote deposit system, according to some embodiments and aspects.

FIG. 5 illustrates an example diagram of a client computing device, according to some embodiments and aspects.

FIG. 6 illustrates an example augmented reality (AR) check capture aid, according to some embodiments and aspects.

FIG. 7 illustrates the example AR check capture aid of FIG. 6, according to some embodiments and aspects.

FIG. 8 illustrates the example AR check capture aid of FIG. 6, according to some embodiments and aspects.

FIG. 9 illustrates a flow diagram for a check capture using the example AR check capture aid of FIGS. 6-8, according to some embodiments and aspects.

FIG. 10 illustrates an example computer system useful for implementing various embodiments and aspects.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method and/or computer program product embodiments, and/or combinations and sub-combinations thereof for implementing an augmented reality (AR) aid on a mobile or desktop computing device to assist, in real-time, a customer electronically depositing a financial instrument, such as a check. AR includes the electronic display of a virtual model of an object within a physical environment. For example, using AR, a mobile or desktop computing device can depict, via a display, a virtual object as occupying a position within a physical environment when the physical environment is within the field of view of a camera coupled to the computing device. The computing device may obtain 3D spatial data from both image analysis and onboard sensors. The computing device may use this data to determine the orientation and/or distance of the computing device with respect to virtual and physical objects within the displayed physical environment.

Utilizing this capability, a customer may be guided toward proper positioning of a camera of a mobile device relative to a financial instrument prior to the capture of an image of or data from the financial instrument. The proper positioning may include both proper position and proper orientation. Accordingly, the quality of an image of the financial document may be increased. Specifically, the likelihood that an image of the financial instrument can be successfully processed (via optical character recognition (OCR) or other methods) to obtain information required for processing an associated transaction may be increased.

Currently, computer-based (e.g., laptop) or mobile-based (e.g., mobile device) technology allows a customer to initiate a document uploading process for uploading images or other electronic versions of a document to a backend system (e.g., a document processing system) for various purposes. Prior to upload, computer-based or mobile-based technology allows a customer to remotely capture an image of the document. But in some cases, camera positioning guidance provided to a customer is based on limited data, if provided at all. For example, existing systems may display a visual guide on the display of a mobile device, and instruct the customer to position the mobile device such that the document is depicted as placed within the guide. However, this approach may ignore or imprecisely evaluate conditions that are important to determining whether a captured image can be successfully processed. Such conditions may include the tilt or skew of the mobile device relative to the document, the distance of the mobile device from the document, etc.

Similarly, existing technology may ascertain relative positioning using a single source of data, such as image analysis. For example, existing systems may determine four corners of a financial instrument are within a field of view of a camera or determine a shape of the financial instrument, using image analysis, and base image capture upon the results. But again, these approaches are susceptible to inaccuracies since data gathered in this way may not be subject to verification or refinement.

These processes are more likely to cause increased error rates, processing costs, and customer frustration. The more accurately technology on a computing device can determine, prior to image or data capture, whether an image to be captured by the computing device will be acceptable for processing a financial transaction, the more efficient and seamless the customer experience will be, and the fewer system and network resources will be required (such as memory space for storing images, processing time associated with processing images of low quality, and network resources associated with sending and receiving images of low quality). For example, accurately predetermining that an image will be acceptable prior to image capture may prevent a customer being required to capture another picture because an image captured and sent to the backend system has been rejected. Accordingly, transaction processing delays may be reduced. Further, processing costs at the backend system may be reduced by accurately predetermining whether an image will be acceptable, as the backend system may be less burdened with rejecting unusable images, communicating with a remote device to initiate image recapture, etc. While existing processes can provide some guard against the capture of unusable images, the systems as disclosed herein may result in higher rates of acceptable image or data capture, leading to a more seamless customer experience and reduced processing costs, both at the customer's computing device and at the bank's backend system. In some embodiments, acceptability of an image refers to whether the image can be processed to extract data from the image (e.g., via OCR) that is necessary for processing a transaction (e.g., a remote deposit). Acceptability of an image may also refer to whether the image will pass various image quality checks (e.g., lighting checks, positioning checks, completeness checks, etc.) performed in existing remote deposit systems post image capture.

Mobile check deposit can be a convenient way to deposit funds using a customer's mobile device or laptop. As financial technology and digital money management tools continue to evolve, the process has become safer and easier. Mobile check deposit is a way to deposit a financial instrument, e.g., a paper check, through a banking app using a smartphone, tablet, laptop, etc. Currently, mobile deposit allows a bank customer to capture a picture of a check using, for example, their smartphone or tablet camera and upload it through a mobile banking app running on the mobile device. Deposits commonly include personal, business, or government checks.

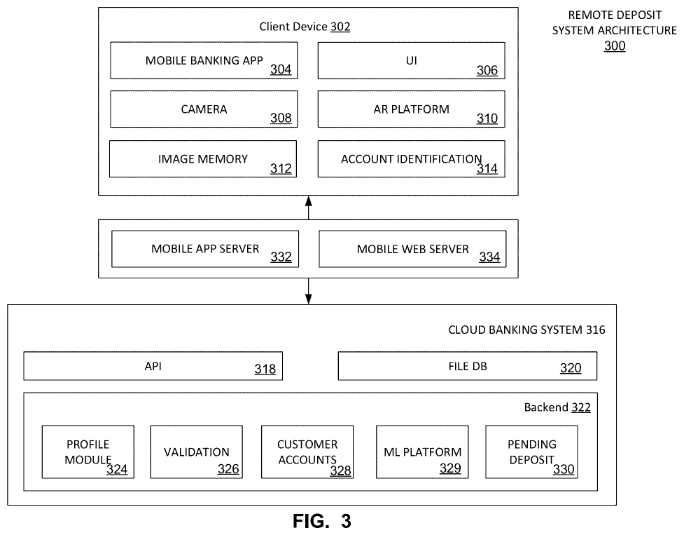

Various aspects of this disclosure may be implemented using and/or may be part of a remote deposit systems shown in FIGS. 3-5. It is noted, however, that this environment is provided solely for illustrative purposes, and is not limiting. Aspects of this disclosure may be implemented using and/or may be part of environments different from and/or in addition to the remote deposit system, as will be appreciated by persons skilled in the relevant art(s) based on the teachings contained herein. An example of the remote deposit system shall now be described.

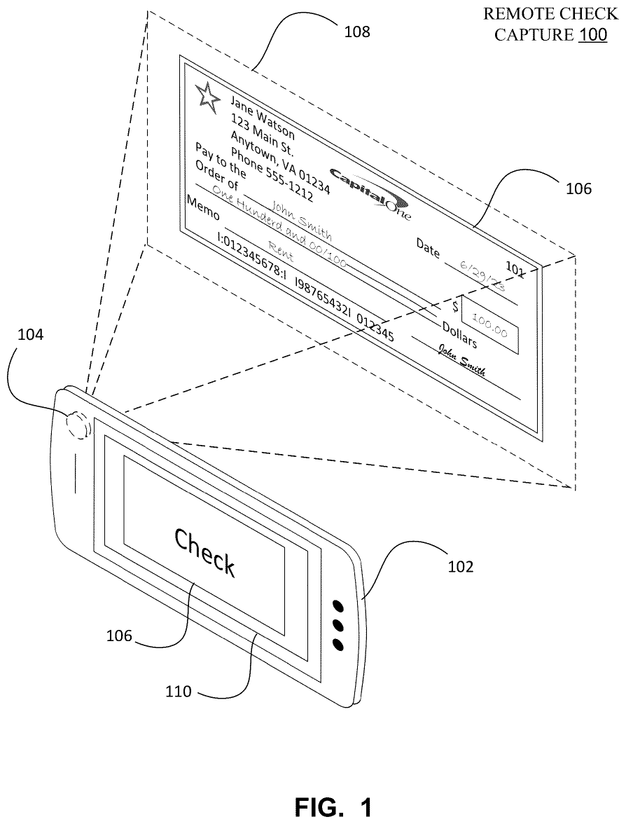

FIG. 1 illustrates an example remote check capture 100, according to some embodiments and aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 1, as will be understood by a person of ordinary skill in the art.

Sample check 106 may be a personal check, paycheck, or government check, to name a few. While sample check 106 is discussed below, other types of financial instruments (e.g., money orders) are contemplated and within the scope of the present disclosure.

In some embodiments, a customer will initiate a remote deposit check capture from their mobile computing device (e.g., smartphone) 102, but other digital camera devices (e.g., tablet computers, personal digital assistants (PDAs), desktop workstations, laptop or notebook computers, wearable computers, such as, but not limited to, Head Mounted Displays (HMDs), computer goggles, computer glasses, smartwatches, etc.), may be substituted without departing from the scope of the technology disclosed herein. For example, when the document to be deposited is a personal check, the customer will select a customer account at the bank account (e.g., checking or savings) into which the funds specified by the check are to be deposited. Content associated with the document include the funds or monetary amount to be deposited to the customer account, the issuing bank, the routing number, and the account number. Content associated with the customer account may include a risk profile associated with the account and the current balance of the account. Options associated with a remote deposit process may include continuing with the deposit process or cancelling the deposit process, thereby cancelling depositing the check amount into the account.

Mobile computing device 102 may communicate with a bank or third party using a communication or network interface (not shown). The communication interface may communicate and interact with any combination of external devices, external networks, external entities, etc. For example, the communication interface may allow mobile computing device 102 to communicate with external or remote devices over a communications path, which may be wired and/or wireless (or a combination thereof), and which may include any combination of LANs, WANs, the Internet, etc. Control logic and/or data may be transmitted to and from mobile computing device via a communication path that includes the Internet.

In an example approach, a customer will login to their mobile banking app, select the account they want to deposit a check into, then select, for example, a “deposit check” option that will activate their mobile device's camera 104. One skilled in the art would understand that variations of this approach or functionally equivalent alternative approaches may be substituted to initiate a mobile deposit.

Using the camera 104 function on the mobile computing device 102, the customer captures live imagery from a field of view 108 that includes at least a portion of one side of sample check 106. Typically, the camera's field of view 108 will include at least the perimeter of the check. However, any camera position that generates in-focus imagery of the various data fields located on a check may be considered. Resolution, distance, alignment, and lighting parameters may require movement of the mobile device until a proper view of a complete check, in-focus, has occurred. An application running on mobile computing device 102 may offer suggestions or technical assistance to guide a proper framing of a check within the mobile banking app's graphically displayed field of view window 110, displayed on a User Interface (UI) instantiated by the mobile banking app. A person skilled in the art of remote deposit would be aware of common requirements and limitations and would understand that different approaches may be required based on the environment in which the check viewing occurs. For example, poor lighting or reflections may require specific alternative techniques. As such, any known or future viewing or capture techniques are considered to be within the scope of the technology described herein. Alternatively, the camera can be remote to the mobile computing device 102. In an alternative embodiment, the remote deposit is implemented on a desktop computing device with an accompanying digital camera.

Sample customer instructions may include, but are not limited to, “Once you've completed filling out the check information and signed the back, it's time to view your check,” “For best results, place your check on a flat, dark-background surface to improve clarity,” “Make sure all four corners of the check fit within the on-screen frame to avoid any processing holdups,” “Select the camera icon in your mobile app to open the camera,” “Once you've viewed a clear image of the front of the check, repeat the process on the back of the check,” “Do you accept the funds availability schedule?” “Swipe the Slide to Deposit button to submit the deposit,” “Your deposit request may have gone through, but it's still a good idea to hold on to your check for a few days,” “Keep the check in a safe, secure place until you see the full amount deposited in your account,” and “After the deposit is confirmed, you can safely destroy the check.” These instructions are provided as sample instructions or comments but any instructions or comments that guide the customer through a remote deposit session may be included. For example, additional or alternative instructions may be provided for guiding a customer through image capture using an augmented reality aid, as described below.

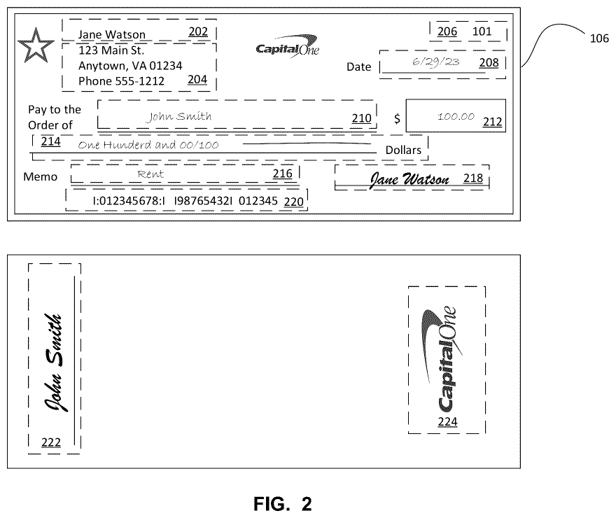

FIG. 2 illustrates example financial instrument field segmentation, according to some embodiments and aspects. Depending on check type, a check may have a fixed number of identifiable fields. For example, a standard personal check may have front side fields, such as, but not limited to, a payer customer name 202 and address 204, check number 206, date 208, payee field 210, payment amount 212, a written amount 214, memo line 216, Magnetic Ink Character Recognition (MICR) line 220 that includes a string of characters including the bank routing number, the payer customer's account number, and the check number and finally the payer customer's signature 218. Back side identifiable fields may include, but are not limited to, payee signature 222 and security fields 224, such as a watermark.

While a number of fields have been described, this description is not intended to limit the technology disclosed herein to these specific fields as a check may have more or less identifiable fields than disclosed herein. In addition, security measures may include alternative approaches discoverable on the front side or back side of the check or discoverable by processing of identified information. For example, the remote deposit feature in the mobile banking app running on the mobile computing device 102 may determine whether the payment amount 212 and the written amount 214 are the same. Additional processing may be needed to determine a final amount to process the check if the two amounts are inconsistent. In one non-limiting example, the written amount 214 may supersede any amount identified within the payment amount field 212.

In some embodiments, the use of an AR remote check image capture aid may include comparing the positions of various identifiable fields of a financial instrument with the positions of corresponding fields of a virtual model of a financial instrument, as described below. The alignment of fields can be used to determine the overall extent of alignment of a physical financial instrument with a virtual model of a financial instrument, as depicted in the display of a computing device.

FIG. 3 illustrates a remote deposit system architecture 300, according to some embodiments and aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 3, as will be understood by a person of ordinary skill in the art.

As described throughout, a client device 302 (e.g., mobile computing device 102) implements remote deposit processing for one or more financial instruments, such as sample check 106. The client device 302 is configured to communicate with a cloud banking system 316 to complete various phases of a remote deposit as will be discussed in greater detail hereafter.

In aspects, the cloud banking system 316 may be implemented as one or more servers. Cloud banking system 316 may be implemented as a variety of centralized or decentralized computing devices. For example, cloud banking system 316 may be a mobile device, a laptop computer, a desktop computer, grid-computing resources, a virtualized computing resource, cloud computing resources, peer-to-peer distributed computing devices, a server farm, or a combination thereof. Cloud banking system 316 may be centralized in a single device, distributed across multiple devices within a cloud network, distributed across different geographic locations, or embedded within a network. Cloud banking system 316 can communicate with other devices, such as a client device 302. Components of cloud banking system 316, such as Application Programming Interface (API) 318, file database (DB) 320, as well as backend 322, may be implemented within the same device (such as when a cloud banking system 316 is implemented as a single device) or as separate devices (e.g., when cloud banking system 316 is implemented as a distributed system with components connected via a network).

Mobile banking app 304 is a computer program or software application designed to run on a mobile device such as a phone, tablet, or watch. However, in a desktop application, a desktop equivalent of the mobile banking app may be configured to run on desktop computers, and web applications, which run in mobile web browsers rather than directly on a mobile device. Applications or apps are broadly classified into three types: native apps, hybrid, and web apps. Native applications may be designed specifically for a mobile operating system, such as iOS or Android. Web apps are designed to be accessed through a web browser. Hybrid apps may be built using web technologies such as JavaScript, CSS, and HTML5, and function like web apps disguised in a native container.

Mobile banking app 304 may include executable software that can communicate with various systems within client device 302 to provide AR functionality. For example, AR software development kits (SDKs), e.g., ARKit (IOS) or ARCore (Android), may be implemented to establish communications between mobile banking app 304 and client device 302's AR capabilities. Mobile banking app 304 may include software instructions that interact with application programing interfaces (APIs), programs, and/or modules provided by an AR SDK. When executed, instructions on mobile banking app 304 may cause AR programs provided through the AR SDK and operating on client device 302 to gather and generate spatial data from both internal sensor data (e.g., gyroscopes, accelerometers, etc.) and image data. As an example, mobile banking app 304 may execute an API call to ARKit or ARCore programs instructing the programs to provide depth data to mobile banking app 304 (e.g., using the Raw Depth API provided by ARCore). The ARKit or ARCore programs may receive image data gathered via a camera of client device 302, inertial sensors, and/or data gathered by time-of-flight (ToF) or light detection and ranging (LiDAR) scanner. The programs may convert this data into a 3D map of a physical environment within the field of view of camera 308 and provide data on points within this 3D map to mobile banking app 304. While ARKit and ARCore are discussed above as example AR SDKs, it should be understood that any suitable AR SDK (e.g., Vuforia, Wikitude, etc.) may be implemented. Various functions of the AR SDK implemented may be integrated with mobile banking app 304, may operate on client device 302 but be separate from mobile banking app 304, or may be implemented on a backend system in communication with client device 302.

Financial instrument imagery may originate from any of, but not limited to, image streams (e.g., series of pixels or frames) or video streams or a combination of any of these or future image formats. A customer using a client device 302, operating a mobile banking app 304 through an interactive UI 306, frames at least a portion of a check (e.g., identifiable fields on front or back of check) with camera 308 (e.g., field of view). In one aspect, imagery is processed from camera 308, as communicated from camera 308 over a period of time. In a non-limiting example, live streamed image data may be assembled into one or more frames of image content. In one aspect, a data signal from a camera sensor (e.g., a charge-coupled device (CCD) or an active-pixel sensor (such as a complementary metal-oxide-semiconductor (CMOS) image sensor)) notifies mobile banking app 304 and/or AR platform 310 when an entire sensor has been read out as streamed data. In this approach, the camera sensor is cleared of electrons before a subsequent exposure to light and a next frame of an image is captured. This clearing function may be conveyed to mobile banking app 304 and/or AR platform 310 to indicate that the Byte Array Output Stream object constitutes a complete frame of image data. In some aspects, the images formed into a byte array may be first rectified to correct for distortions based on an angle of incidence, may be rotated to align the imagery, may be filtered to remove obstructions or reflections, and may be resized to correct for size distortions using known image processing techniques. In one aspect, these corrections may be based on recognition of corners or borders of the check as a basis for image orientation and size, as is known in the art.

In one aspect, the camera imagery is streamed as encoded text, such as a byte array. Alternatively, or in addition to, the live imagery is buffered by storing (e.g., at least temporarily) as images or frames in computer memory. For example, live streamed check imagery from camera 308 is stored locally in image memory 312, such as, but not limited to, a frame buffer, a video buffer, a streaming buffer, or a virtual buffer.

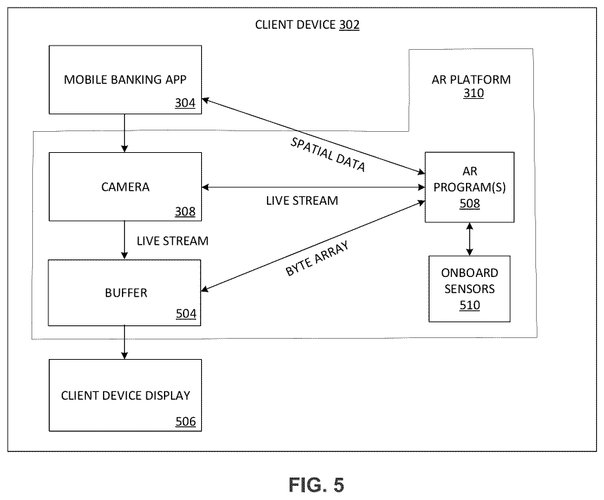

AR platform 310, resident on client device 302, may process live streamed check imagery from camera 308 and/or buffered image data from image memory 312 to determine spatial data. AR platform 310 may also process data from other onboard sensors within client device 302. AR platform 310 will be described in more detail below with respect to FIG. 5.

Account identification 314 uses single or multiple level login data from mobile banking app 304 to initiate a remote deposit. Alternately, or in addition to, an extracted payee field 210 or the payee signature 222 may be used to provide additional authentication of the customer.

Backend 322 may include one or more system servers processing banking deposit operations in a secure environment. These one or more system servers operate to support client device 302. API 318 is an intermediary software interface between mobile banking app 304, installed on client device 302, and one or more server systems, such as, but not limited to the backend 322, as well as third party servers (not shown). The API 318 is available to be called by mobile clients through a server, such as a mobile edge server (not shown), within cloud banking system 316. File DB 320 stores files received from the client device 302 or generated as a result of processing a remote deposit.

Profile module 324 retrieves customer profiles associated with the customer from a registry after extracting customer data from front or back images of the financial instrument. Customer profiles may be used to determine deposit limits, historical activity, security data, or other customer related data.

Validation module 326 generates a set of validations including, but not limited to, any of: mobile deposit eligibility, account, image, transaction limits, duplicate checks, amount mismatch, MICR, multiple deposit, etc. While shown as a single module, the various validations may be performed by, or in conjunction with, the client device 302, cloud banking system 316, or third party systems or data.

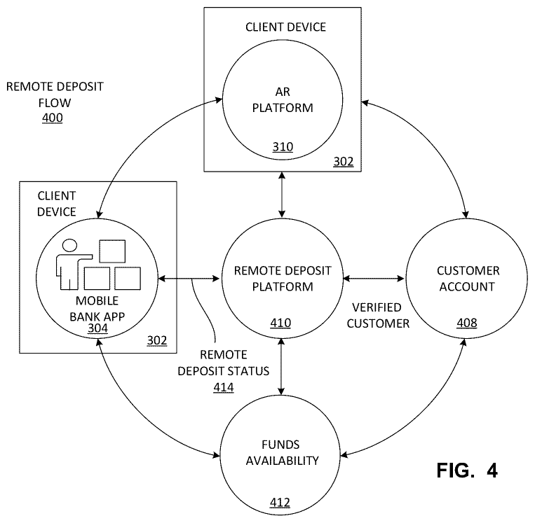

Customer accounts 328 (consistent with customer account 408 of FIG. 4) includes, but is not limited to, a customer's financial banking information, such as individual, joint, or commercial account information, balances, loans, credit cards, account historical data, etc.

In some embodiments, artificial intelligence (AI), such as machine-learning (ML) systems train model(s) to recognize sizes, shapes, and identifiable field and text patterns of financial instruments (e.g., sample check 106). The model(s) may also receive and analyze AR spatial data such as relative distance of client device 302 from financial instrument, relative tilt, relative skew, relative lateral displacement, etc. associated with a captured image. The model(s) may be resident on client device 302 and may be integrated with or be separate from mobile banking app 304. Some or all of the model(s) may also operate in cloud banking system 316. The model(s) may be continuously updated by future transactions used to train the model(s).

ML involves computers discovering how they can perform tasks without being explicitly programmed to do so. ML includes, but is not limited to, artificial intelligence, deep learning, fuzzy learning, supervised learning, unsupervised learning, etc. Machine learning algorithms build a model based on sample data, known as “training data,” in order to make predictions or decisions without being explicitly programmed to do so. For supervised learning, the computer is presented with example inputs and their desired outputs and the goal is to learn a general rule that maps inputs to outputs. In another example, for unsupervised learning, no labels are given to the learning algorithm, leaving it on its own to find structure in its input. Unsupervised learning can be a goal in itself (discovering hidden patterns in data) or a means towards an end (feature learning).

A machine-learning engine may use various classifiers to map concepts associated with an AR session to capture relationships between concepts (e.g., distance of client device 302 from financial instrument, relative tilt, relative skew, relative lateral displacement, etc.) and financial instrument processing success rates. The classifier (discriminator) is trained to distinguish (recognize) variations. Different variations may be classified to ensure no collapse of the classifier and so that variations can be distinguished.

In some aspects, machine learning models are trained on a remote machine learning platform (e.g., MP platform 329) using other customer's transactional information (e.g., data from previous AR aided image or data capture sessions). In addition, large training sets of the other customer's historical information may be used to normalize prediction data (e.g., not skewed by a single or few occurrences of a data artifact). Thereafter, AR image or data capture aid predictive model(s) may classify a specific condition (e.g., distance of client device 302 from financial instrument, relative tilt, relative skew, relative lateral displacement, etc.) against the trained predictive model to predict image usability or update thresholds for image capture conditions. In one embodiment, the models are continuously updated as new financial transactions occur.

In some aspects, a ML engine may continuously change weighting of model inputs to increase customer interactions with AR aided image capture procedures. For example, weighting of specific data fields may be continuously modified in the model to trend towards greater success, where success is recognized by correct data field extractions or by completed remote deposit transactions. Conversely, term weighting that lowers successful AR aided image capture sessions may be lowered or eliminated.

ML platform 329 may include such trained model(s) or a ML engine to train such model(s). A model may be used to extract and process data on sizes, shapes, and identifiable field and text patterns of financial instruments associated with a customer account 328 (e.g., previously deposited checks). In addition to the functions described above, ML Platform 329 may use the extracted and processed data to build or update virtual 2D or 3D models of financial instruments that more closely match a customer's transaction history, as described below. ML platform 329 may also include a trained OCR model or a ML engine to train OCR model(s) used to extract and process OCR data.

This disclosure is not intended to limit ML platform 329 to only image acceptability model generation, virtual model building, or OCR model generation as it may also include, but should not be limited to, remote deposit models, risk models, funding models, security models, etc.

When remote deposit status information is generated, it is passed back to the client device 302 through API 318 where it is formatted for communication and display on the client device 302 and may, for example, communicate a funds availability schedule for display or rendering on the customer's device through the mobile banking app UI 306. The UI may instantiate the funds availability schedule as images, graphics, audio, additional content, etc.

Pending deposit 330 includes a profile of a potential upcoming deposit(s) based on an acceptance by the customer through UI 306 of a deposit according to given terms. If the deposit is successful, the flow creates a record for the transaction and this function retrieves a product type associated with the account, retrieves the interactions, and creates a pending check deposit activity.

Alternatively, or in addition to, one or more components of the remote deposit process may be implemented within the client device 302, third party platforms, the cloud-based banking system 316, or distributed across multiple computer-based systems. The UI may instantiate the remote deposit status as images, graphics, audio, additional content, etc. In one technical improvement over current processing systems, the remote deposit status is provided mid-stream, prior to completion of the deposit. In this approach, the customer may terminate the process prior to completion if they are dissatisfied with the remote deposit status.

In one embodiment, remote deposit system 300 tracks customer behavior. For example, did the customer complete a remote deposit operation or did they cancel the request? In some aspects, the completion of the remote deposit operation reflects a successful outcome, while a cancellation reflects a failed outcome. In some aspects, this customer behavior, not limited to success/failure, may be fed back to the ML platform 329 to enhance future training of a remote deposit model. For example, in some embodiments, one or more inputs to the ML remote deposit models may be weighted differently (higher or lower) to effect a predicted higher successful outcome.

FIG. 4 illustrates an example state diagram of a remote deposit system, according to some embodiments and aspects. The remote deposit flow 400 may include one or more system servers processing banking deposit operations in a secure closed loop. While described for a mobile computing device, desktop solutions may be substituted without departing from the scope of the technology described herein. These system servers may operate to support mobile computing devices from the cloud. It is noted that the structural and functional aspects of the system servers may wholly or partially exist in the same or different ones of the system servers or on the mobile device itself. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 4, as will be understood by a person of ordinary skill in the art.

In one non-limiting example, a bank customer using a client device 302 (e.g., mobile computing device 102), operating a mobile banking app 304, frames at least a portion of a check within a field of view from an active camera (e.g., camera port opened) of client device 302. As previously described, the imagery within the field of view may, in one aspect, be configured as a live stream. In one aspect, the camera imagery is streamed as encoded text, such as a byte array (e.g., as a Byte Array Output Stream object).

After a frame of the image stream including the check is captured, OCR processing may be required. OCR processing may occur on either client device 302 or in cloud banking system 316. OCR processing may include, but is not limited to, extraction of data from the identifiable fields of the check, verification of data extracted from the fields based on a comparison with historical customer account data found in customer account 408 or the payer's account. The customer account 408, for purposes of description, may be the payee's account, the payer's account or both. For example, a payee's account historical information may be used to calculate a payee's funds availability 412 schedule, while a payer's account may be checked for funds to cover the check amount. In one non-limiting example, an address may be checked against the current address found in a data file of customer account 408. In another non-limiting example, OCR processing may include checking a signature file within customer account 408 to verify the payee or payer signatures. It is also contemplated that a third party database can be checked for funds and signatures for checks from payers not associated with the customer's bank. Additional known OCR processing techniques may be substituted without departing from the scope of the technology described herein.

A funds availability 412 model may return a fixed or dynamically modifiable funds availability schedule to the UI 306 on the client device 302.

Check images obtained by client device 302 may be transmitted and stored in the customer account 408 for later use if necessary.

Remote deposit platform 410 computes a funds availability schedule based on one or more of the received data fields, customer history received from the customer's account 408, bank funding policies, legal requirements (e.g., state or federally mandated limits and reporting requirements, etc.), or typical schedules stored within a funds availability 412 platform, to name a few. For example, OCR processing may identify the MICR data as a verified data field that may be used to access customer account 408. This access allows the bank identified in the MICR to provide a history of customer account 408 to the Remote deposit platform 410. Early access to customer account 408 may also provide a verified customer for security purposes to eliminate or reduce fraud early in the remote deposit process.

Remote deposit platform 410 may communicate a remote deposit status 414 to client device 302. For example, the acceptance of the OCR processed data may be communicated. Alternatively, a request to again point the camera at one or more sides of the check may be communicated to and rendered as on-screen instructions on the client device 302, within one or more customer user interfaces (UIs) of client device 302's mobile banking app 304. The rendering may include imagery, text, or a link to additional content. The UI may instantiate the remote deposit status 414 as images, graphics, audio, etc. In one technical improvement over current processing systems, the remote deposit status is provided mid-stream, prior to completion of the deposit. In this approach, the customer may terminate the process prior to completion if they are dissatisfied with the remote deposit status 414.

In one embodiment, remote deposit platform 410 tracks customer behavior. For example, did the customer complete a remote deposit operation or did they cancel the request? In some aspects, the completion of the remote deposit operation reflects a successful outcome, while a cancellation reflects a failed outcome. In some aspects, this customer behavior, not limited to success/failure, may be fed back to ML platform 329 within the remote deposit platform 410 to enhance future training of a ML AR image capture aid model or remote deposit models. For example, in some embodiments, one or more inputs to the ML models may be weighted differently (higher or lower) to effect a predicted higher successful outcome.

Alternatively, or in addition to, one or more components of the remote deposit flow may be implemented within the customer device, third party platforms, and a cloud-based system or distributed across multiple computer-based systems.

FIG. 5 illustrates an example diagram of a client device 302, according to some aspects. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 5, as will be understood by a person of ordinary skill in the art.

In one embodiment, the mobile banking app 304 is opened on the client device 302 and the deposit check function selected to initiate a remote deposit process. A camera viewport is opened for camera 308 to communicate a live stream of imagery (e.g., frames of video) from a field of view of the camera 308. Camera 308 may output, for display at client device display 506, a frame (e.g., an image frame or a frame of a video, for example) having one or more images (e.g., images of real-world objects) that are viewable by camera 308. An image frame may include one or more images that may represent one or more real-world objects. For instance, an image may represent an entire group of checks in a field of view of camera 308, or the image may represent one or more individual objects within the group. In one aspect, the image of decodable check indicia can be provided by a raw image byte stream or by a byte array, a compressed image byte stream or byte array, and/or a partial compressed image byte stream or byte array.

At this point, the customer of the client device 302 may view the live stream of imagery on a UI of the client device display 506, after buffering in buffer 504 (e.g., frame buffer, video buffer, etc.). In some embodiments, the live stream may be communicated to AR program(s) 508 as a raw image live stream. In some embodiments, the raw image live stream may first be converted to a byte array and then communicated to AR program(s) 508 (buffered or not buffered). The data embedded in the byte stream or byte array may then be extracted by program instructions of AR program(s) 508 of AR platform 310 and used to generate spatial data that can then be provided by AR program(s) 508 to mobile banking app 304. This generated spatial data may be continuously or periodically transmitted upon a request from mobile banking app 304. AR program(s) 508 may be programs provided as part of AR SDKs such as ARKit or ARCore. AR program(s) 508 may be implemented on client device 302 using API calls executed by mobile banking app 304. In some embodiments, AR program(s) 508 may be integrated within mobile banking app 304. In some embodiments, AR program(s) 508 may be separate from mobile banking app 304. In some embodiments, AR program(s) 508 may be partially integrated within mobile banking app 304 and partially separate from mobile banking app 304.

As shown in FIG. 5, AR platform 310 may also include onboard sensors 510. Onboard sensors 510 may include a gyroscope, an accelerometer, a magnetometer, time-of-flight (ToF) sensor, structured light illumination (SLI) sensor, light detection and ranging (LiDAR) sensor, etc. Onboard sensors 510 may provide data that may be used, along with image data from camera 308, to determine spatial data. In some embodiments onboard sensors 510 may include an inertial measurement unit (IMU), which may include three accelerometers, three gyroscopes, and three magnetometers.

AR program(s) 508 may consider and use data from both camera 308 and onboard sensors 510 in determining position and orientation of objects a physical environment. For example, AR program(s) 508 may use visual-inertial odometry or simultaneous localization and mapping (SLAM) to accurately calculate position and orientation. Using visual-inertial odometry or SLAM, AR program(s) 508 can determine specific features within the physical environment and track differences in the positions of the specific features from frame to frame within an image stream. AR program(s) 508 can combine data obtained through image analysis with data from onboard sensors 510 (e.g., an IMU and/or LiDAR sensor) to determine real-world position and orientation (pose) of physical and virtual objects. By determining 3D spatial position and orientation data for various objects within a physical environment in this way, AR program(s) 508 may provide accurate data useful for instructing a customer to position client device 302 (e.g., mobile computing device 102) correctly relative to a financial instrument prior to image capture. Using multiple sources of data to determine relative position and orientation may lead to more precise determinations of these conditions. When these conditions are used as conditions for capture of an image of a financial instrument, a substantial increase in the success rate of obtaining usable images may be attained.

To map a physical environment, AR program(s) 508 may start by identifying feature points within images received from camera 308 (e.g., camera 104). These feature points are tied to distinctive features within images, for example, corners, dots, or other patterns that may be reliably identified from frame to frame as a user moves client mobile computing device 102. These feature points may be identified using any suitable algorithm, such as the Binary Robust Invariant Scalable Keypoints (BRISK) algorithm, the Features from Accelerated Segment Test (FAST) algorithm, or any algorithm used with common AR SDKs such as ARKit or ARCore. For example, the BRISK and FAST algorithms may identify a feature point by comparing the relative brightness of adjacent pixels within an image.

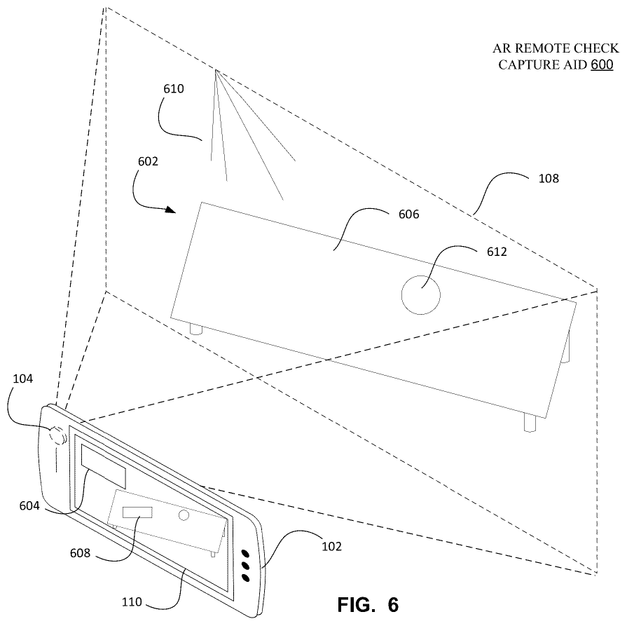

Once AR program(s) 508 identify feature points, AR program(s) 508 may track the positions within an image frame of various feature points from frame to frame. AR program(s) 508 may gather data on the position of a feature point within an initial frame as compared to its position in a subsequent frame. Using inertial data from onboard sensors 510 (e.g., accelerometers, gyroscopes, and/or magnetometers), AR program(s) 508 may determine a change in orientation and/or position of camera 104 between capture of the initial frame and the subsequent frame. By combining information on the change in position of a feature point between frames and the change in orientation and/or position of camera 104, AR program(s) 508 may determine a distance between camera 104 and the feature point based on the change in position of the feature point between frames. Using this method for many feature points, AR program(s) 508 may generate a 3D map of physical environment 602's feature points, the accuracy of which improves as a user moves camera 104 within physical environment 602, as shown in FIG. 6. AR program(s) 508 may compile data describing each of the feature points, for example, position within a coordinate system defined by AR program(s) 508. AR program(s) may also track the position and orientation of mobile computing device 102 within this 3D map. This data may be available to mobile banking app 304.

Alternatively, or in addition to, the above method of determining distance to a feature point, mobile computing device 102 may use dual camera or dual pixel technology to determine a distance between camera 104 and the feature point. Using dual camera technology, mobile computing device 102 may simultaneously capture a stereo pair of images from two apertures. AR program(s) 508 may use the distance between the apertures, the focal length of the cameras, and the difference in position of the feature point within the images (known as the disparity) to compute a distance from camera 104 to the feature point. Camera 104 may include two or more apertures to facilitate more accurate tracking of distance and relative orientation. Dual pixel technology, or Dual Pixel Autofocus (DPAF) technology, operates on a similar principle, though it is two images captured by two photodiodes within a single pixel of a camera sensor that are compared.

Alternatively, or in addition, AR program(s) 508 may implement single image methods for determining distance from camera 104 to various features within a captured image. For example, AR program(s) 508 may interact with a trained ML model running on mobile computing device 102 or a backend server to output the second image of a stereo image pair from a single image. AR program(s) 508 may then use the stereo image pair to calculate distance, as described above for dual camera technology. Alternatively, AR program(s) 508 may interact with a trained ML model running on mobile computing device 102 or a backend server to obtain a depth map from a captured image. The model may be trained on pairs of images each including an image and an RGB-D depth map associated with the image.

Alternatively, or in addition, AR program(s) 508 may use direct sensor data to determine a distance between camera 104 and a surface within physical environment 602. For example, mobile computing device 102 may include a ToF sensor or a LiDAR sensor that directly measures distance by computing the phase shift between an emitted and reflected light beam (ToF) or time between emitted and reflected laser pulses (LiDAR). As a nonlimiting example, a ToF or LiDAR sensor may be used to determine distance 810 (while the ToF or LiDAR sensor is not shown in FIGS. 6-8, it may be included adjacent camera 104). AR program(s) 508 may receive and compile distance information obtained by these sensors.

However AR program(s) 508 determine the position of feature points and/or distance to real world objects, AR program(s) 508 may compile this data and transmit it to mobile banking app 304. AR program(s) 508 may transmit this data to mobile banking app 304 in various forms. For example, in some embodiments, AR program(s) 508 may transmit data on a feature point basis. Accordingly, mobile banking app 304 may receive data on or derived from the position of all or a subset of the feature points identified by AR program(s) 508. In alternative embodiments, AR program(s) 508 may transmit data on a pixel-by-pixel basis or based on a defined location within field of view 108. Accordingly, for each pixel in an image frame or for a defined location within field of view 108, mobile banking app 304 may receive data on the distance from camera 104 to a surface within physical environment 602 depicted in the pixel.

AR program(s) 508 may process raw feature point data to detect shapes defined by objects within a physical environment. AR program(s) 508 may provide data on these shapes to mobile banking app 304, thus reducing the amount of computation executed on mobile banking app 304 (i.e., that would otherwise be required to process raw feature point data into usable information). For example, AR program(s) 508 may use a plane detection function to determine the position and orientation of sample check 106 from feature points within field of view 108. AR program(s) 508 may identify feature points that occupy a common surface, and determine whether the feature points are substantially coplanar. Upon identifying a plane, AR program(s) 508 may determine its position (e.g., a position of its center point), the positions of its vertices (e.g., corners), the positions of points along its boundaries, its length, its width, its tilt (e.g., defined based on a vector normal to its surface, which may be defined relative to a gravity vector), and/or its skew (e.g., defined based on a direction of its lengthwise and/or widthwise axis). This information may be requested by mobile banking app 304.

Mobile banking app 304 may request the distance of a feature point or object (e.g., a plane) recognized by AR program(s) 508 to camera 104 at any point within field of view 108. For example, mobile banking app 304 may implement a raycast function (also known as hit testing). Using a raycast function, mobile banking app may define a location within field of view 108 (e.g., a center point of field of view 108 as displayed on field of view window 110) and request information on a distance from camera 104 to a surface or feature point at that location within field of view 108. AR program(s) 508 may return the depth of a feature point or recognized real world surface at the point of intersection with the “ray” that is cast from camera 104 toward the defined location within field of view 108.

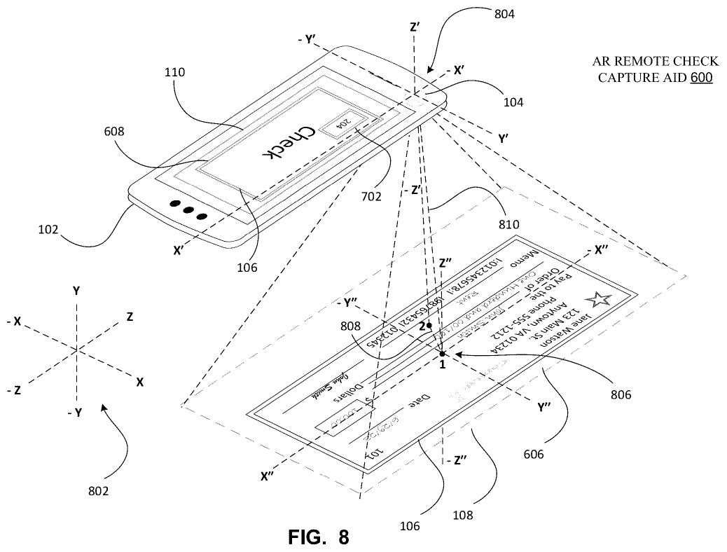

For a feature point, an object (e.g., a plane), a virtual model displayed (using AR platform 310) as occupying a portion of a physical environment, and mobile computing device 102 itself, AR program(s) 508 may enable determining position and orientation (pose) within a coordinate system, such as the three coordinate systems described below. For ease of illustration, these coordinate systems will be described with respect to FIG. 8.

World Coordinate System: The world coordinate system 802 may be defined with respect to a gravity vector (determined using an accelerometer within mobile computing device 102) and the orientation of mobile computing device 102 upon initiation of an AR session. For example, the Y axis may be aligned with the gravity vector, the Z axis may point in the direction camera 104 faces upon initiation of the session but perpendicular to the gravity vector, and the X axis may be orthogonal to the Y and Z axes. The origin of world coordinate system 802 may be mobile computing device 102's initial position. World coordinate system 802 remains fixed as mobile computing device 102 moves (e.g., camera 104's coordinates will change as it moves). Position may be expressed as coordinates with respect to the origin of world coordinate system 802 (X, Y, Z). Orientation may be determined based on the angle of one or more axes (e.g., axis Z′) of the coordinate system of an object (e.g., mobile computing device 102) relative to one or more axes of world coordinate system 802 (e.g., axis Z). The orientation may be expressed in quaternions or Euler angles.

Camera Coordinate System: The camera coordinate system 804 may be defined with respect to the camera position and orientation. For example, the Y′ axis may point upward, the Z′ axis may point toward a viewer, and the X′ axis may point to the viewer's right. The origin of camera coordinate system 804 may be the center of camera 104. Camera coordinate system 804 is fixed to camera 104 and is constant with respect to camera 104 (e.g., objects within the physical environment will have different coordinates in camera coordinate system 804 based on movement of only camera 104). Position may be expressed as coordinates with respect to the origin of camera coordinate system 804 (X′, Y′, Z′). Orientation may be determined based on the angle of one or more axes (e.g., axis Z″) of the coordinate system of an object (e.g., sample check 106) relative to one or more axes of camera coordinate system 804 (e.g., axis Z′). The orientation may be expressed in quaternions or Euler angles.

Object Coordinate System: An object coordinate system 806 may be defined with respect to the position and orientation of an object. The object may be an anchor (e.g., a plane identified by AR program(s) 508) or it may be a virtual object rendered in the physical environment. If a plane, the plane may correspond to an object such as sample check 106. The axes may be defined with respect to the orientation of the object. For example, the Z″ axis may be aligned with an axis normal to the surface of the object (if a plane), the X″ axis may be aligned with a lengthwise axis of the object, and the Y″ axis may be aligned with a widthwise axis of the object. Object coordinate system 806 is fixed to the object and is constant with respect to the object (e.g., camera 104 will have different coordinates in object coordinate system 806 based on movement of only the object). Position may be expressed as coordinates with respect to the origin of object coordinate system 806 (X″, Y″, Z″). Orientation may be determined based on the angle of one or more axes (e.g., axis Z′) of the coordinate system of an object (e.g., camera coordinate system 804) relative to one or more axes of object coordinate system 806 (e.g., axis Z″). The orientation may be expressed in quaternions or Euler angles.

The pose (position and orientation) of any object in a coordinate system of interest may be obtained from the transformation of the object's coordinate system (e.g., its origin and axes) to the coordinate system of interest. In some embodiments, mobile banking app 304 may obtain the pose of an object within a coordinate system by comparing the world coordinate system pose of the object's coordinate system with the world coordinate pose of the coordinate system of interest (e.g., the camera coordinate system). In some embodiments, AR program(s) 508 may perform the comparison and provide the pose of the object within the coordinate system of interest upon the request of mobile banking app 304.

FIG. 6 illustrates the use of an AR remote check capture aid 600 in line with the discussion above. AR remote check capture aid 600 may be implemented when a user initiates remote image capture within mobile banking app 304. In some embodiments, AR remote check capture aid 600 may be implemented as a default setting upon a first image capture by the user, thus familiarizing the user with the remote image capture process. Thereafter, AR remote check capture aid 600 may be toggled on and off by the user. In other embodiments, a user must toggle on AR remote check capture aid 600 even upon a first attempt to capture an image. In yet other embodiments, the AR remote check capture aid 600 may be on by default and the user may optionally toggle it off for each image capture.

Client device 302 (such as mobile computing device 102 shown in FIG. 6) may include a camera 308 (such as camera 104 shown in FIG. 6) that can be directed toward a portion of a physical environment 602, as shown in FIG. 6. The portion of physical environment 602 (i.e., that within field of view 108 of camera 104) may be displayed in field of view window 110 within mobile banking app 304. Physical environment 602 may be displayed as an image stream in response to the user initiating remote image capture. As the user moves mobile computing device 102 and camera 104, various portions of physical environment 602 may be displayed in field of view window 110 on client device display 506 as a live video stream.

In some embodiments, mobile banking app 304 may display user instructions 604 on client device display 506 (within or outside of field of view window 110). User instructions 604 may include directions to point camera 104 toward a portion of physical environment 602 including a substantially level surface, such as surface 606. Surface 606 may be that of a table, desk, chair, floor, counter, bed, etc. User instructions 604 may include, “Direct the camera toward a level surface,” “Direct the camera toward a flat surface,” “Direct the camera toward an even surface,” or any other variation of this instruction. User instructions 604 may include additional directions as the process of remote image capture proceeds, as described below.

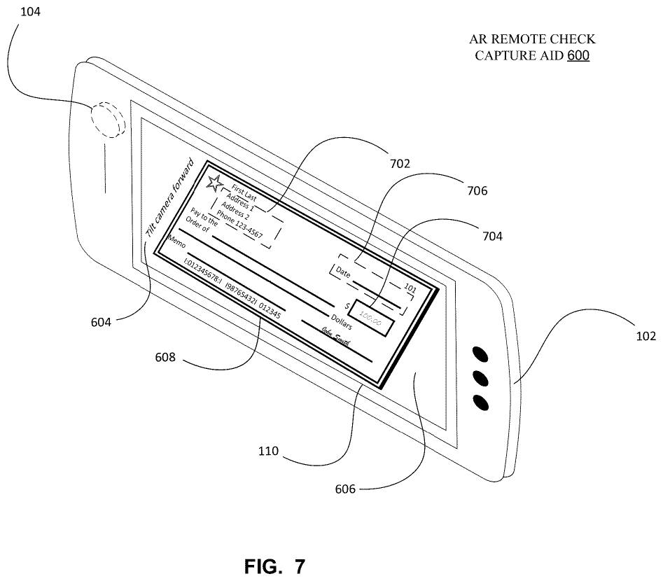

In some embodiments, user instructions 604 may be displayed as a text box on the display of mobile computing device 102, as shown in FIG. 6. In alternative embodiments, mobile banking app 304 may display, by interacting with AR platform 310, user instructions 604 as virtual instructions that are depicted as having a position and/or orientation within physical environment 602, as shown in FIG. 7. That is, user instructions 604 may be a virtual model (or multiple virtual models) which may be depicted in field of view window 110 as positioned within physical environment 602 using AR platform 310. In some embodiments, user instructions 604 may be depicted as positioned on a surface within physical environment 602, such as surface 606. User instructions 604 may be depicted as positioned adjacent one or more borders of a financial instrument, such as sample check 106 of FIG. 1. In some embodiments, user instructions 604 may be depicted as positioned in the air of physical environment 602, such as above surface 606 and/or adjacent a financial instrument. In some embodiments, user instructions 604 may be depicted as positioned adjacent one or more edges of a virtual model of a financial instrument, such as virtual model 608 discussed below and shown in more detail in FIG. 7.

In some embodiments, upon a request from mobile banking app 304, AR platform 310 may analyze surfaces within physical environment 602 and field of view 108 to determine their characteristics. For example, AR program(s) 508 may execute image analysis, combined with analyzing data from onboard sensors 510, to map the surface contours of various surfaces within physical environment 602. AR program(s) 508 may identify feature points that occupy a common surface, and determine whether the feature points are substantially coplanar. Accordingly, AR program(s) 508 may identify substantially planar surfaces.

Additionally, AR program(s) 508 may identify substantially planar surfaces that are substantially horizontal. A substantially horizontal planar surface may be a surface for which an axis normal to the surface is substantially parallel to the gravity vector. As a non-limiting example, using ARCore, mobile banking app 304 might execute Config.PlaneFindingMode HORIZONTAL to enable horizontal plane detection by AR program(s) 508. As an additional non-limiting example, using ARKit, mobile banking app 304 might execute configuration.planeDetection=[.horizontal] to enable horizontal plane detection by AR program(s) 508. In some embodiments, AR program(s) 508 may further be able to classify horizontal planar surfaces (e.g., label them as floors, walls, tables, ceilings, etc.). AR program(s) 508 may provide information on horizontal planar surfaces to mobile banking app 304 so that these surfaces may be used for the placement of a virtual object, such as virtual model 608. Accordingly, using AR platform 310 as directed via mobile banking app 304, mobile computing device 102 may identify a substantially level (i.e., substantially planar and substantially horizontal) surface for the placement of virtual model 608. By “substantially level,” it should be understood that AR program(s) 508 estimate surface geometry in identifying horizontal planar surfaces, such that the identified surfaces are not perfectly planar or horizontal. However, a “substantially level” surface should be one that is identifiable as a horizontal plane using an AR enabled platform.

Once mobile banking app 304 receives information from AR program(s) 508 regarding substantially level surfaces, mobile banking app 304 may select an identified surface for the placement of virtual model 608. Mobile banking app 304 may select an identified surface based on a type of surface determined by AR program(s) 508, for example, selecting a table but rejecting a ceiling or floor. Further, mobile banking app 304 may select an identified surface based on a color of the surface (e.g., by obtaining color data of pixels associated with feature points of the identified surface), such that mobile banking app 304 may select a dark surface suitable for providing contrast with a financial instrument.

Mobile banking app 304 may select surface 606, as shown in FIG. 6. Mobile banking app 304 may then provide data for rendering virtual model 608 within physical environment 602 to AR program(s) 508. Mobile banking app 304 may provide the file for virtual model 608, along with position information and orientation information in the world coordinate system or an object coordinate system associated with surface 606. AR program(s) 508 may then anchor the virtual model 608 within either of these coordinate systems and communicate a composite image stream to buffer 504 which includes the image stream obtained from camera 104 and a rendering of virtual model 608 within physical environment 602. The composite image stream may then be displayed on client device display 506, such as in field of view window 110.

In some embodiments, virtual model 608 may be depicted as having a position and orientation relative to surface 606. For example, virtual model 608 may be depicted as occupying a certain portion of surface 606 and may be depicted as being arranged at a certain angle on surface 606 (i.e., its lengthwise axis may point in a certain direction). In some embodiments, virtual model 608 may have a fixed position and orientation relative to surface 606. For example, when a user moves camera 104, virtual model 608 may remain stationary on surface 606. Accordingly, the user may view virtual model 608 in field of view window 110 from various angles and at various distances while virtual model 608 is depicted as stationary within physical environment 602, as shown in FIG. 7.

In some embodiments, mobile banking app 304 may select surface 606 and/or the pose of virtual model 608 relative to surface 606 based on a lighting condition 610. For example, mobile banking app 304 may request lighting information from AR program(s) 508. This lighting information may include a direction and/or intensity of a light source in physical environment 602. This lighting information may also include an intensity of ambient light within various portions of physical environment 602. Based on the lighting information, mobile banking app 304 may select an optimal placement of virtual model 608. For example, mobile banking app 304 may select a portion of surface 606 for the placement of virtual model 608 that corresponds to a point of highest ambient light intensity on surface 606. Additionally or alternatively, mobile banking app 304 may consider the direction of a light source within physical environment 602 and choose a portion of surface 606 that would prevent a shadow of mobile computing device 102 from falling over a financial instrument aligned with virtual model 608 during remote image capture.

Alternatively, or in addition, mobile banking app 304 may select the orientation of virtual model 608 relative to surface 606 based on a position of another object 612 within physical environment 602. For example, mobile banking app 304 may request data on positions of features points from AR program(s) 508. In some embodiments, using the feature points, mobile banking app 304 may determine that an object 612 is occupying a portion of surface 606. In alternative embodiments, AR program(s) 508 may recognize object 612 and provide information to mobile banking app 304 regarding its position and orientation. Mobile banking app 304 may select a portion of surface 606 for the placement of virtual model 608 that would prevent object 612 from being included in an image of a financial instrument aligned with virtual model 608.

In alternative embodiments, the position and orientation of virtual model 608 within physical environment 602, such as its orientation relative to surface 606, may be selected by a user. For example, mobile banking app 304 may display a representation of virtual model 608 and instruct, via user instructions 604, the user to place the model within physical environment 602 by dragging and dropping the representation of virtual model 608. This may be performed via a user interaction with the client device display 506 when client device display 506 is a touch screen, or by another user input mechanism (e.g., mouse). In such embodiments, mobile banking app 304 and/or AR program(s) 508 may highlight or otherwise indicate more desirable positions and orientations for the placement of virtual model 608, for example, a portion of a substantially level surface that has sufficient lighting and is free of other objects. Mobile banking app 304 may receive information on more desirable positions and orientations from AR program(s) 508 or may determine the more desirable locations based on data received from AR program(s) 508. As an example, mobile banking app 304 and/or AR program(s) 508 may indicate more desirable positions and orientations with green highlighting or arrows that are rendered as virtual objects using AR platform 310.

Whether virtual model 608 is automatically placed by mobile banking app 304 and/or AR Program(s) 508, or manually placed by a user, in some embodiments, virtual model 608 may be manipulated by the user. For example, the position and orientation of virtual model 608 may be adjusted by the user via a user interaction with client device display 506 when client device display 506 is a touch screen. The user interaction may be a gesture. For example, the user may drag virtual model 608 and drop it at a different position. Or the user may place his or her finger on a predetermined portion (e.g., a corner) of virtual model 608 and flip virtual model by moving his or her finger in an arc (or other predefined motion). Upon capture of an image of a front side image of a financial instrument, mobile banking app 304 may instruct a user to flip the financial instrument. User instructions 604, either graphical or textual, may illustrate or describe how to flip the financial instrument.

Once virtual model 608 is rendered as part of physical environment 602, mobile banking app 304 may direct a user to position a financial instrument such that the financial instrument is aligned with virtual model 608. For example, user instructions 604 may direct the user to “Place your check inside the virtual check,” “Align the corners of your check with the corners of the virtual check,” “Align the fields of your check with the fields of the virtual check,” or any similar actions.

FIG. 7 illustrates virtual model 608 as depicted within physical environment 602, shown in FIG. 6. As shown in FIG. 7, virtual model 608 may be a virtual model of a financial instrument, such as a check. However, virtual model 608 is not limited to a virtual model of a financial instrument. In some embodiments, virtual model 608 may be an abstract representation of a shape of a financial instrument. For example, virtual model 608 may include or be an outline or bracket(s). In some embodiments, virtual model 608 may include or be a solid shape, such as a rectangle, with or without markings. In some embodiments, virtual model 608 may be a virtual model of a financial instrument such as a check, with only a subset of the identifiable fields commonly included on a check. In some embodiments, virtual model 608 may be a virtual model of a financial instrument such as a check, with all identifiable fields commonly included on a check. In some embodiments, virtual model 608 may be depicted on a UI of a client device (e.g., UI 306 of client device 302) as having a position and orientation within a physical environment (e.g., physical environment 602). In some embodiments, such as when the virtual model is fixed with respect to the world coordinate system, the virtual model can move on the UI as the user moves the client device. In alternative embodiments, such as when then virtual model is fixed with respect to the camera coordinate system, the virtual model can be stationary on the UI but still be depicted as occupying the physical environment (though its position and orientation within the physical environment will move as the user moves the client device).

Virtual model 608 may be rectangular (2D) or a rectangular prism (3D). In some embodiments, virtual model 608 may be a 3D virtual model having length, width, and depth. In alternative embodiments virtual model 608 may be a 2D virtual model having length and width. Virtual model 608 may be made up of a 3D mesh including points, lines, and faces that define the features of virtual model 608 (e.g., borders, faces, and/or identifiable fields of a check). When displayed, virtual model 608 may be partially transparent such that a financial instrument aligned with virtual model 608 may be visible, and the extent of the financial instrument's alignment may be visually detected by a user. Virtual model 608 may be stored on mobile computing device 102 and accessible by mobile banking app 304. Virtual model 608 may be initially generated on cloud banking system 316 based on an image or images and provided to mobile banking app 304. In alternative embodiments, virtual model 608 may be generated on mobile computing device 102 based on an image or images and at the direction of mobile banking app 304.

In some embodiments, virtual model 608 may include a plurality of identifiable fields, such as one or more of the identifiable fields shown and described with respect to FIG. 2. FIG. 7 identifies virtual model address field 702, virtual model payment amount 704, and virtual model date field 706. While only these three fields are identified in FIG. 7, it should be understood that virtual model 608 may include any or all of the field types identified in FIG. 2 and discussed above. While not shown, virtual model 608 may include identifiable fields on its back side, including a payee signature field.

In some embodiments, an identifiable field of virtual model 608 may be empty, such as virtual model date field 706 (i.e., no date provided). An identifiable field of virtual model 608 being empty may assist a user with aligning a financial instrument with virtual model 608. For example, a user may align sample check 106 with virtual model 608 such that either handwritten or typed text of an identifiable field of sample check 106 is depicted as located within an empty field of virtual model 608, thus creating a depiction of a completed field. In some embodiments, an identifiable field of virtual model 608 may include generic text, such as virtual model address field 702 (“Address 1; Address 2; Phone 123-4567”). An identifiable field of virtual model 608 including generic text may assist the user with aligning a financial instrument with virtual model 608. For example, a user may align sample check 106 with virtual model 608 such that either handwritten or typed text of an identifiable field of sample check 106 is depicted as overlapping generic text of virtual model 608. Alternatively, once properly aligned, the handwritten or typed text of an identifiable field of sample check 106 may replace the generic text shown in the virtual model 608.

In some embodiments, virtual model 608 may be generated at client device 302 (e.g., mobile computing device 102), for example, using mobile banking app 304. In alternative embodiments, virtual model 608 may be generated within cloud banking system 316, for example, by ML platform 329, and communicated to mobile computing device 102.

In some embodiments, virtual model 608 may be generated based on ANSI standards for patterns, text, and dimensions of checks. Accordingly, the size, shape, and field placement of virtual model 608 can be more likely to correspond to check being deposited by a user. In some embodiments, multiple virtual models may be provided to a user during use of AR remote check capture aid 600. For example, mobile banking app 304 may provide, via UI 306, a selection of virtual models of various sizes, proportions, and field and text arrangements. The multiple virtual models may be generated on cloud banking system 316 and stored on mobile computing device 102. Alternatively, the multiple virtual models may be generated on mobile computing device 102 at the direction of mobile banking app 304. The user may select the virtual model 608 that best corresponds to the financial instrument of which images are being captured. This may better provide for instances in which the user's financial instrument significantly deviates from a default virtual model or is noncompliant with ANSI standards (e.g., a treasury check).

In some embodiments, for example, when virtual model 608 is generated within cloud banking system 316, ML platform 329 may receive and analyze images of financial instruments associated with past transactions of a customer. Based on data on size, shape, and/or identifiable field and text patterns extracted by a model running on ML platform 329, ML platform 329 can generate virtual models of financial instruments that more closely align with deposit patterns of a user. For example, ML platform 329 may detect that a user repeatedly deposits a check type from a particular issuer, and generate a duplicate virtual model of the check type that mobile banking app 304 may provide to the user as a selectable virtual model choice. ML platform 329 may detect that a certain percentage (e.g., 80%) of a user's deposited financial instruments share at least one of size, shape, or identifiable field and text patterns, and generate a virtual model including the overlapping size, shape, and/or identifiable field and text patterns. As the model running on ML platform 329 obtains more data from additional customer transactions, ML platform 329 may update previous virtual models to better align with the additional data. ML platform 329 may provide any virtual model it generates or updates to mobile banking app 304 such that mobile banking app 304 may display the virtual model using AR platform 310. In some embodiments, a model trained by ML platform 329 but running on mobile computing device 102 may provide the same functionality.

In some embodiments, a user may scan a financial instrument and convert the financial instrument to a virtual model in real time, such that the financial instrument of which images are being captured exactly matches virtual model 608. Mobile banking app 304 may instruct the user to obtain image data that may be used to generate virtual model 608 upon initiation of AR remote check capture aid 600. In such embodiments, mobile banking app 304 may instruct the user to move camera 308 (e.g., camera 104 of mobile computing device 102) around the financial instrument until enough image data for creation of virtual model 608 is captured. The image data may include data derived from images captured by camera 104 using AR program(s) 508 (e.g., feature point data). In some embodiments, mobile banking app 304 may transmit this image data to cloud banking system 316 where virtual model 608 may be generated. In alternative embodiments, mobile banking app 304 may interact with programs on mobile computing device 102 that may generate virtual model 608 based on the image data.

FIG. 8 further illustrates the use of AR remote check capture aid 600. As shown in FIG. 8, client device 302 (e.g., mobile computing device 102) may determine its position and orientation (pose) relative to a financial instrument (e.g., sample check 106). Mobile computing device 102 may do so using any of the methods described above. AR program(s) 508 may identify sample check 106 as a plane, define it as an anchor, and define its object coordinate system 806. Using AR program(s) 508, mobile banking app 304 may transform object coordinate system 806 to camera coordinate system 804. The resulting data may include the pose of a plane approximating sample check 106 in camera coordinate system 804.

Mobile banking app 304 may use different methods to obtain effectively the same result. For example, mobile banking app 304 may compare object coordinate system 806's pose in world coordinate system 802 with camera coordinate system 804's pose in world coordinate system 802 to obtain the difference in the positions and orientations of sample check 106 and camera 104.

The resulting data may be used as a basis to trigger automatic image capture of sample check 106. Automatic image capture may be based on the relative position of camera 104 and sample check 106, the relative orientation of camera 104 and sample check 106, or a combination of the relative position and the relative orientation of camera 104 and sample check 106. Non-limiting examples of techniques for determining relative position and relative orientation are discussed below.

Automatic image capture may be triggered when the relative position (e.g., the coordinates of sample check 106 within camera coordinate system 804) indicates that sample check 106 is within a predetermined range of distances 810 from camera 104 and within a predetermined range of lateral displacements 808. As an example, distance 810 may be determined by comparing the coordinates of the origin of object coordinate system 806 with the coordinates of the origin of camera coordinate system 804 (e.g., [0, 0, 0] in camera coordinate system 804) and applying mathematical formulas. While shown as the distance between the origin of camera coordinate system 804 and object coordinate system 806, distance 810 may be the distance from camera 104 to any point on sample check 106, and may be determined using any of the methods identified above for distance determination (e.g., ToF/LiDAR sensing, raycasting, etc.). Lateral displacement 808, illustrated as the distance between points 1 and 2 in FIG. 8, may also be determined by comparing the coordinates of the origin of object coordinate system 806 with the coordinates of the origin of camera coordinate system 804 (e.g., [0, 0, 0] in camera coordinate system 804) and applying mathematical formulas. For example, lateral displacement may be the length of a vector from the (X′, Y′) coordinates of the origin of camera coordinate system 804 (e.g., [0, 0]) to the (X′, Y′) coordinates of the origin of object coordinate system 806.

The predetermined range of distances 810 and predetermined range of lateral displacements may be set by mobile banking app 304. In some embodiments, the range of distances 810 and/or lateral displacements 808 may be based on a focal length of a lens of camera 104 and/or the current optical zoom setting. In some embodiments, the units for distance 810 and lateral displacement 808 may be meters. In some embodiments, the predetermined range of distances 810 and predetermined range of lateral displacements 808 may be updated by a model (e.g., an ML model) running on either mobile banking app 304 or ML platform 329 based on data associating distance and lateral displacement data with rates of successful image processing.

In some embodiments, mobile banking app 304 may include instructions to automatically capture an image of sample check 106 when distance 810 is within about 0.15 m to about 1 m, such as within about 0.175 m to about 0.75 m, about 0.2 to about 0.5 m, or about 0.25 to about 0.35 m. In some embodiments, the current optical zoom setting may be considered in combination with the distance 810 to determine when to trigger automatic image capture.

In some embodiments, mobile banking app 304 may include instructions to automatically capture an image of sample check 106 when lateral displacement 808 is within about 0 to about 0.10 meters, such as within about 0 to about 0.075 m, about 0 to about 0.05 m, about 0 to about 0.025 m, or about 0 to about 0.01 m. In some embodiments, the current optical zoom setting may be considered in combination with the lateral displacement 808 to determine when to trigger automatic image capture.

Automatic image capture may be triggered when the relative orientation (e.g., the orientation of object coordinate system 806 within camera coordinate system 804) indicates that a difference between the orientation of sample check 106 and camera 104 is within a predetermined range. As noted above, relative orientation may be determined by comparing the orientation of camera coordinate system 804 in world coordinate system 802 with the orientation of object coordinate system 806 in world coordinate system 802, and/or by determining the orientation of object coordinate system 806 in camera coordinate system 804.

Various components of the difference in orientation may be analyzed separately. That is, the difference in orientation around various axes of either world coordinate system 802 or camera coordinate system 804 may be analyzed. The difference in orientation of sample check 106 and camera 104 may be based on a difference in skew, a difference in horizontal tilt, and/or a difference in vertical tilt.

Difference in Skew: The difference in skew between sample check 106 and camera 104 may be determined based on an angle between axis X′ and a projection of axis X″ onto the X′-Y′ plane, with a larger angle indicating a larger difference in skew. Alternatively or additionally, the difference in skew may be determined based on an angle between axis Y′ and a projection of axis Y″ onto the X′-Y′ plane.

Difference in Horizontal Tilt: The difference in horizontal tilt between sample check 106 and camera 104 may be determined based on an angle between axis X′ and a projection of axis X″ onto the X′-Z′ plane, with a larger angle indicating a larger difference in horizontal tilt. Alternatively or additionally, the difference in horizontal tilt may be determined based on an angle between axis Z′ and a projection of axis Z″ onto the X′-Z′ plane.

Difference in Vertical Tilt: The difference in vertical tilt between sample check 106 and camera 104 may be determined based on an angle between axis Y′ and a projection of axis Y″ onto the Y′-Z′ plane, with a larger angle indicating a larger difference in vertical tilt. Alternatively or additionally, the difference in vertical tilt may be determined based on an angle between axis Z′ and a projection of axis Z″ onto the Y′-Z′ plane.

The difference in orientation as a whole may be calculated from data that describes these individual differences (i.e., data extracted from either Euler angles or quaternions). In some embodiments, the automatic image capture decision may be based on the difference in orientation as a whole, while in other embodiments, the automatic image capture decision may be based on one or more of the individual component differences in orientation described above being within a predetermined component difference range.

In some embodiments, the difference in orientation around all axes may be considered equally in determining the difference in orientation as a whole (or in determining whether automatic image capture should be performed based on individual component differences in orientation). In alternative embodiments, the difference in orientation around one axis may be weighted more highly than the difference in orientation around another axis. This may be useful when a difference in orientation around one axis is less impactful in determining whether an image will be usable. For example, the difference in skew of sample check 106 and camera 104 may be weighted less than a difference in tilt of sample check 106 and camera 104. This may be because skew may not affect the distance of points of sample check 106 to camera 104 as much as tilt. Likewise, the difference in vertical tilt may be weighted less than the difference in horizontal tilt, as relative vertical tilt may not affect the distance of points of sample check 106 to camera 104 as much as relative horizontal tilt since sample check 106 is longer in the horizontal direction (along axis X″). Weighting various aspects of the difference in orientation differently may decrease user frustration (conditions for automatic image capture may be less confined) while still ensuring that accurate determinations of whether an image will be usable may be made prior to image capture.

The predetermined range of orientation differences (or predetermined component difference ranges) of camera 104 and sample check 106 may be set by mobile banking app 304. In some embodiments, the predetermined ranges may be updated by a model (e.g., an ML model) running on either mobile banking app 304 or ML platform 329 based on data associating differences in orientations (including differences by component) with rates of successful image processing.

In some embodiments, mobile banking app 304 may include instructions to automatically capture an image of sample check 106 when the skew of mobile computing device 102 is different from the skew of sample check 106 by about 0 to about 15%, such as about 0 to about 12.5%, about 0 to about 10%, about 0 to about 7.5%, about 0 to about 5%, about 0 to about 2.5%, or about 1%. (The percentage may be measured, for example, based on the extent of rotation, in degrees, of axes X″ and Y″ around axis Z.)

In some embodiments, mobile banking app 304 may include instructions to automatically capture an image of sample check 106 when a tilt of mobile computing device 102 (e.g., vertical tilt or horizontal tilt) is different from a tilt of sample check 106 (e.g., vertical tilt or horizontal tilt) by about 0 to about 15%, such as about 0 to about 12.5%, about 0 to about 10%, about 0 to about 7.5%, about 0 to about 5%, about 0 to about 2.5%, or about 0 to about 1%. (The percentage may be defined, for example, based on an angle of rotation of axes X″ and Z″ around axis Y′ or axes Y″ and Z″ around axis X′).

Mobile banking app 304 may include instructions to automatically capture an image of sample check 106 based on any one or any combination of the above conditions (distance; lateral displacement; and relative orientation, including any individual orientation components).

While distance to, lateral displacement from, and relative orientation have all been discussed above with respect to camera 104 and sample check 106, mobile banking app 304 may also determine the above conditions for camera 104 and virtual model 608 (or even surface 606) using the same principles (where object coordinate system 806 is the coordinate system tied to virtual model 608). This may be more efficient for mobile banking app 304 since the position (e.g., world coordinate system 802 coordinates) and orientation (e.g., world coordinate system 802 Euler angles) of virtual model 608 within the world coordinate system may be set by mobile banking app 304, in communication with AR program(s) 508. Accordingly, the pose of virtual model 608 may be easily accessible by mobile banking app 304. Alternatively, or in addition to, the above methods, a distance to, lateral displacement from, and orientation relative to virtual model 608 may be considered in determining whether to automatically capture an image of sample check 106.

In the above description, mobile banking app 304 relies on AR program(s) 508 to identify an object (e.g., a plane) corresponding to sample check 106. However, mobile banking app may also (additionally or alternatively) determine the same conditions described above by requesting and processing raw feature point and/or sensor data. Mobile banking app 304 may interpret raw data to determine lateral displacement 808, distance 810, and relative orientation (e.g., difference in skew, difference in horizontal tilt, and difference in vertical tilt) of camera 104 and sample check 106. For example, mobile banking app 304 may calculate distances from mobile computing device 102 to a variety of feature points of sample check 106 based on the position of camera 104 within the world coordinate system. The position of mobile camera 104 may be requested from AR program(s) 508, and may be calculated by AR program(s) 508 based on internal sensor data and image data, as described above for determining the position of a feature point. Based on the distances of camera 104 to one or more feature points of sample check 106, mobile banking app 304 may determine lateral displacement 808, distance 810, and skew, horizontal tilt, and vertical tilt relative to sample check 106.

As a non-limiting example, mobile banking app 304 may identify feature points associated with the corners of sample check 106. Using the distances to each of the four corners of sample check 106, mobile banking app 304 may calculate sample check 106's vertical tilt, horizontal tilt, and skew in an image (i.e., relative to camera 104). Further, mobile banking app 304 may calculate the position of center point 1 of sample check 106, based on the distance to or position of feature points associated with the corners of sample check 106. Based on the position of center point 1, mobile banking app 304 may calculate lateral displacement 808, which may be represented by the distance between the center point and point 2, where point 2 lies in the center of field of view 108 and on sample check 106 or surface 606 and may be identified by raycasting. Based on the position of center point 1 and the position of camera 104, which may both be determined using AR program(s) 508, mobile banking app 304 may calculate distance 810. While shown as a distance from camera 104 to center point 1 in FIG. 8, in some embodiments, distance 810 may be the distance from camera 104 to any feature point of sample check 106, or to point 2. Distance may be determined or corroborated using data from onboard sensors 510, for example, ToF or LiDAR sensor data.

In some embodiments, mobile banking app 304 may use the positions of three feature points of sample check 106 to calculate a vector normal to the surface of sample check 106. Mobile banking app 304 may compare this vector to a vector defining the direction camera 104 is pointing (e.g., the −Z′ axis) to obtain relative vertical tilt and relative horizontal tilt. In some embodiments, mobile banking app 304 may use the positions of the corner feature points to determine a lengthwise axis and widthwise axis of sample check 106 (e.g., along axes X″ and Y″, respectively). Mobile banking app 304 may determine measures of the angles between projections of these axes onto the X′-Y′ plane and the X′ and Y′ axes, respectively, to obtain relative skew.

Alternatively, or in addition to, the above methods, mobile banking app 304 may set a baseline orientation of mobile computing device 102 such that returning to the baseline orientation may serve as a condition for automatic capture of an image of sample check 106. For example, mobile banking app 304 may instruct a user via user instructions 604 to position mobile computing device 102 on surface 606. Mobile computing device 102 may be positioned upside down on surface 606 (i.e., camera 104 is pointing upward). When in this position, mobile banking app 304 may mark the orientation of mobile computing device 102 (determined based on data from accelerometer, gyroscope, and/or magnetometer data) as a baseline orientation (adjusting for mobile computing device 102's inverted state by transforming its rotation around axis X′ by 180 degrees). When mobile computing device 102 is removed from surface 606 and camera 104 is directed toward surface 606, mobile banking app 304 may render virtual model 608 as having the same orientation, in world coordinate system 802 as the baseline orientation (though the position of virtual model 608 may differ on surface 606). Therefore, a user positioning sample check 106 to be aligned with virtual model 608 will ensure sample check 106 is arranged substantially in the baseline orientation.

When the user conducts image capture using AR remote check capture aid 600, mobile banking app 304 may detect when mobile computing device 102 returns to the baseline orientation. This condition being fulfilled, along with mobile banking app 304 determining that camera 104 is a proper distance from sample check 106 as described above, may trigger auto capture of an image of sample check 106. Automatic image capture need not be triggered by mobile computing device 102 being exactly in the baseline orientation. Instead, mobile banking app 304 may define ranges of differences in mobile computing device 102's orientation and the baseline orientation acceptable for automatic image capture (e.g., within 15% of a baseline tilt and 15% of a baseline skew, or any other percentage difference between 0 and 15%, 0 and 10%, or 0 and 5%).

As noted above, AR program(s) 508 may generate data on mobile computing device 102's position and orientation within a world coordinate system using both image analysis and internal sensor data. For example, in addition to using image analysis, AR program(s) 508 may determine mobile computing device 102's vertical tilt, horizontal tilt, and skew based on data received from an accelerometer and gyroscope within mobile computing device 102. The accelerometer data may provide insights on mobile computing device 102's tilt relative to the gravity vector. Gyroscope data on rotation of mobile computing device 102 since the initiation of an AR session may be used by AR program(s) 508 to determine skew. Accordingly, onboard sensor data may be used to continually refine data on the position and orientation of mobile computing device 102 in world coordinate system 802. Further, onboard sensor data (e.g., ToF or LiDAR senor data) may be particularly useful when feature points of a surface are difficult to detect due to the surface's visual uniformity.

In some embodiments, prior to triggering automatic image capture, mobile banking app 304 may calculate a confidence score indicating a likelihood of accurately extracting data from an image of a financial instrument (e.g., sample check 106), for example, using OCR. The confidence score may be based on lateral displacement 808, distance 810, and/or relative orientation (including relative horizontal tilt, relative vertical tilt, and/or relative skew), as determined using any of the methods described above. The calculation of the confidence score may weight different of these factors equally or differently, as described above. The weighting of these factors may be based on the strength of their association with successful image processing, which may be determined using, for example, a linear regression model. The weighting of these factors may be continually updated by a ML model based on historical data of values for the factors and data extraction results associated with an image.

In some embodiments, automatic image capture may be based on the confidence score exceeding a predetermined threshold. For example, the predetermined threshold may be 90% confidence or above, such as 92% confidence or above, 94% confidence or above, 96% confidence or above, 98% confidence or above, 99% confidence or above, or 100% confidence.

While the axes of FIG. 8 and the described methods are used to visually represent the relative distance and orientation of camera 104 and sample check 106, it should be understood that AR software (e.g., AR program(s) 508) and/or mobile banking app 304 operating on mobile computing device 102 may define or determine relative distances and orientations in different manners. These axes are broadly used to illustrate the conditions (e.g., relative position and orientation) mobile banking app 304 is concerned with when determining whether to execute automatic capture of an image or instruct a user to adjust the positioning of mobile computing device 102. Further, any descriptions or definitions of distance, lateral displacement, and relative orientations (e.g., difference in skew, difference in horizontal tilt, difference in vertical tilt) that rely on the illustrated axes are used to illustrate conditions of interest, and are not intended to limit this disclosure to any single mathematical and/or computer programing method of measuring or determining the conditions. Any measure for or method of determining the above conditions is considered within the scope of this disclosure.

In some embodiments, mobile banking app 304 may determine an extent of alignment of a financial instrument (e.g., sample check 106) and virtual model 608. Mobile banking app 304 may do this using a variety of techniques, which may be used in any combination or alone. Mobile banking app 304 may determine the extent of alignment based on whether virtual model 608 overlays all corners of sample check 106. Additionally or alternatively, mobile banking app 304 may determine the extent of alignment based on an overlap of an identifiable field of virtual model 608 (e.g., virtual model address field 702) and a corresponding identifiable field of sample check 106 (e.g., address field 204). The overlap may be quantified as a percentage of overlap of areas of virtual model 608 and sample check 106 associated with the fields. The overlap may also be quantified as a percentage of overlap of generic text of virtual model 608 and handwritten or typed text of sample check 106. The overlap of areas or overlap of text may be determined by mobile banking app 304 based on sample check 106 feature point data (coordinates of feature points on sample check 106) and data on the coordinates of points or other features of the model mesh as rendered in world coordinate system 802. Mobile banking app 304 may determine the extent of alignment based on an overlap of multiple identifiable fields of virtual model 608 and their corresponding identifiable fields on sample check 106.

In some embodiments, mobile banking app 304 may further include instructions to automatically capture an image of sample check 106 based on extent of alignment of sample check 106 with virtual model 608. The extent of alignment may be determined in a variety of ways. As noted above, the position (e.g., world coordinate system coordinates) and at least one aspect of orientation (e.g., skew) of virtual model 608 within the world coordinate system may be set by mobile banking app 304. Tilt may be predetermined based on the tilt of surface 606. Accordingly, the position and orientation of virtual model 608 may be available to mobile banking app 304. In some embodiments, mobile banking app 304 may determine the extent of alignment of sample check 106 with virtual model 608 by comparing the position and orientation of sample check 106 as determined in the above disclosure with the position and orientation of virtual model 608.

For example, mobile banking app 304 may determine that the distance from an origin of an object coordinate system tied to virtual model 608 to the origin of object coordinate system 806 tied to sample check 106 is less than a predetermined threshold distance. Mobile banking app 304 may include instructions to automatically capture an image of sample check 106 when the distance is less than the threshold distance, in combination with any other conditions described above. The threshold distance may be about 0.10 meters, about 0.075 m, about 0.05 m, about 0.025 m, or about 0.01 m.

Additionally, mobile banking app 304 may determine that a difference between a skew of sample check 106 and a skew of virtual model 608 is within a predetermined threshold difference. Mobile banking app 304 may include instructions to automatically capture an image of sample check 106 when the difference is less than the threshold difference, in combination with any one or more of the other conditions described above. The threshold difference may be about 15%, about 12.5%, about 10%, about 7.5%, about 5%, about 2.5%, or about 1%. (The percentage may be defined, for example, based on an angle of rotation of axes X″ and Y″ around an axis of virtual model 608's coordinate system that is parallel to axis Z″).

In some embodiments, mobile banking app 304 may determine the extent of alignment of sample check 106 with virtual model 608 by determining whether virtual model 608 overlay all corners of sample check 106. For example, mobile banking app 304 may receive data on the positions of the corners of sample check 106 via plane detection (or may determine the positions of the corners from raw feature point data), and may compare the positions of the corners to positions of the boundaries of virtual model 608 as defined by points in the virtual model mesh. By determining that the corners fall within the boundaries of virtual model 608, mobile banking app 304 may conclude that virtual model 608 overlays all corners of sample check 106. Mobile banking app 304 may include instructions to automatically capture an image of sample check 106 when virtual model 608 overlays all corners of sample check 106, in combination with any one or more of the other conditions described above.

In some embodiments, the extent of alignment (or its individual components) may be factored into the confidence score discussed above.

It may be particularly useful to determine the extent of alignment of sample check 106 with virtual model 608 in embodiments in which mobile banking app 304 determines the relative distance and orientation of mobile computing device 102 with respect to virtual model 608 rather than sample check 106. As noted above, position and orientation information of vertical model 608 may be readily available to mobile banking app 304. Accordingly, in some embodiments, mobile banking app 304 may base automatic image capture on 1) the distance from camera 104 to virtual model 608 as rendered in the physical environment, 2) the lateral displacement of camera 104 and virtual model 608, 3) the difference in orientation of camera 104 and virtual model 608, and 4) the extent of alignment of sample check 106 and virtual model 608, according to all the definitions of these terms set forth above. In alternative embodiments, mobile banking app may base automatic image capture on 1) the distance from camera 104 to virtual model sample check 106, 2) the lateral displacement of camera 104 and sample check 106, and 3) the difference in orientation of camera 104 and sample check 106, without considering the extent of alignment of virtual model 608 and sample check 106. In such embodiments, the rendering of virtual model 608 may serve as a useful tool for enhancing customer engagement and selecting a suitable surface/location for placement of a financial instrument for capture of an acceptable image, but the alignment may not affect automatic capture.

In further alternative embodiments, rather than placing virtual model 608 as fixed relative to world coordinate system 802, mobile banking app 304 may fix virtual model 608 in camera coordinate system 804. For example, mobile banking app 304 may fix virtual model 608 at an optimal distance from camera 104 and set virtual model 608's orientation to match that of camera 104. For example, virtual model 608's lengthwise axis may be parallel to axis X′, its widthwise axis may be parallel to axis Y′, and its heightwise axis (or a vector normal to its surface) may be parallel to axis Z′. The optimal distance may be determined based on a focal length of a lens of camera 104 and/or the current optical zoom setting. In some embodiments, the optimal distance may be updated based on a ML model's association of optimal distances implemented and successful image processing. The model may be trained on ML platform 329 and implemented either on mobile computing device 102 or ML platform 329.

In some embodiments, the optimal distance may be within about 0.15 m to about 1 m, such as within about 0.175 m to about 0.75 m, about 0.2 to about 0.5 m, or about 0.25 to about 0.35 m.

In such embodiments, mobile banking app 304 may instruct a customer to place a financial instrument on a flat (e.g., a substantially level) surface or a location of a surface (using any of the methods described above). For example, mobile banking app 304 may interact with AR program(s) 508 to identify appropriate surfaces and/or locations on a surface and highlight these surfaces and/or locations, as described above. Mobile banking app 304 may further instruct the customer to align virtual model 608 with the financial instrument. For example, user instructions 604 may include, “Align the virtual model with the check,” or any other similar instructions. In such embodiments, automatic image capture may be triggered based on alignment of sample check 106 and virtual model 608, which may be determined using the methods described above.

The above disclosure describes the use of virtual model 608 to assist a user in positioning a check, such as sample check 106, and positioning camera 104 properly relative to sample check 106. However, in some embodiments, no virtual model 608 need be used. In such embodiments, mobile banking app 304 may identify, using AR platform 310, an appropriate surface and/or location for the placement of sample check 106, instruct a user to position sample check 106 on the surface and/or in the location, and/or use AR platform 310 to assist the user in properly positioning camera 104 relative to sample check 106, using any of the systems and methods described herein. However, in such embodiments, mobile banking app 304 need not display virtual model 608.

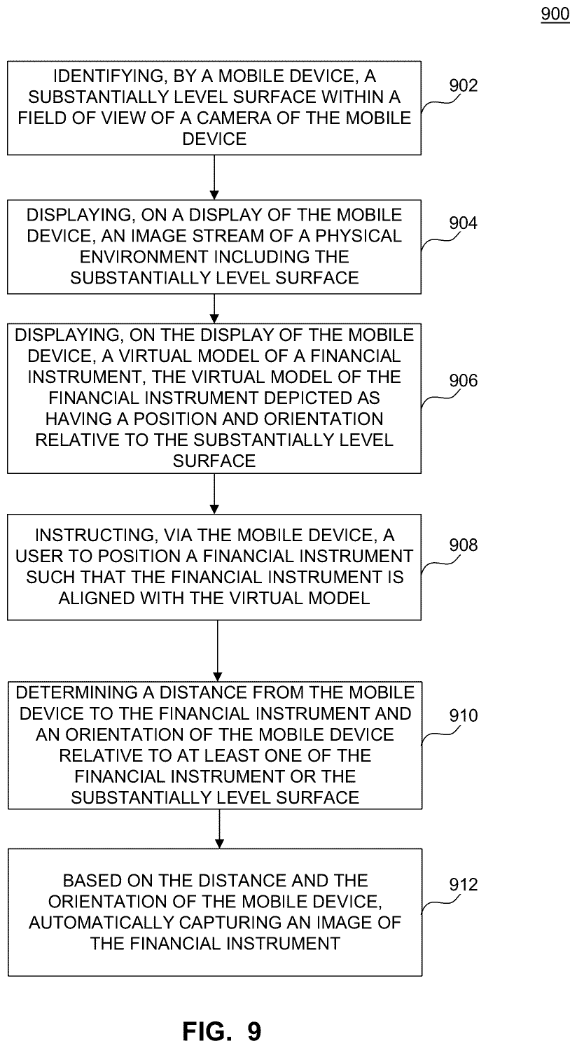

FIG. 9 is a flow chart depicting a method 900 for an automatic image capture method that can be carried out in line with the discussion above. One or more of the operations in the method depicted by FIG. 9 could be carried out by one or more entities, including, without limitation, client device 302, remote deposit platform 410, or other server or cloud-based server processing systems and/or one or more entities operating on behalf of or in cooperation with these or other entities, unless otherwise noted. Any such entity could embody a computing system, such as a programmed processing unit or the like, configured to carry out one or more of the method operations. Further, a non-transitory data storage (e.g., disc storage, flash storage, or other computer readable medium) could have stored thereon instructions executable by a processing unit to carry out the various depicted operations. In some aspects, the systems described generate and instantiate an AR aided check capture process for a mobile banking app 304.

Step 902 may include identifying, by mobile computing device 102, a substantially level surface within field of view 108 of camera 104 of mobile computing device 102. For example, mobile banking app 304 may direct AR program(s) 508 to detect a horizontal plane within field of view 108, as described above. Mobile banking app 304 may direct AR program(s) 508 to detect a horizontal plane upon initiation of AR remote check capture aid 600 by a bank customer using mobile banking app 304. The customer may initiate AR remote check capture aid 600 by selecting this option on a UI of the mobile banking app 304 on mobile computing device 102. This selection provides instructions to AR program(s) 508 via mobile banking app 304. Once AR program(s) 508 have identified a horizontal plane within field of view 108, AR program(s) 508 may communicate data on this plane (position, shape, orientation, etc.) to mobile banking app 304. Mobile banking app 304 may select a horizontal plane provided by AR program(s) 508 as a surface 606 for rendering virtual model 608. In some embodiments, mobile banking app may select surface 606, and/or a portion on surface 606, for rendering virtual model 608 based on a lighting condition 610 and/or relative position of another object 612.

Step 904 may include displaying, on a display of mobile computing device 102 (e.g., within field of view window 110), an image stream of physical environment 602 including surface 606 (a substantially level surface as identified in step 902). The image stream may be a live image stream received from camera 104. The image stream may show a portion of physical environment 602 within field of view 108 of camera 104.

Step 906 may include displaying, on the display of mobile computing device 102, virtual model 608, virtual model 608 being depicted as having a position and orientation relative to surface 606 (the substantially level surface). Mobile banking app 304 may interact with AR platform 310 to render virtual model 608 as depicted within physical environment 602. Virtual model 608 may be a virtual model of a financial instrument, as described above. For example, virtual model 608 may be a virtual model of a check with identifiable fields. The identifiable fields may be configured to be aligned with corresponding fields of a financial instrument (e.g., sample check 106). For example, see fields 702, 704, and 706 described above.

In some embodiments, the position of virtual model 608 may be selected, at mobile computing device 102, based on a lighting condition 610 in physical environment 602. In some embodiments, the position of virtual model 608 may be selected, at mobile computing device 102, based on a position of another object 612 within physical environment 602. In some embodiments, the orientation of virtual model 608 may be manipulated by a user. In some embodiments, method 900 may further include instructing, via mobile computing device 102, the user to turn over virtual model 608.

In some embodiments, virtual model 608 may be selectable by the user among a plurality of virtual models of financial instruments. In some embodiments, method 900 may further include displaying, on the display of mobile computing device 102, an updated virtual model, the updated virtual model having been updated based on previous images of financial instruments associated with an account of the user. For example, virtual model 608 may be updated using a trained ML model (e.g., trained on ML platform 329).

Step 908 may include instructing, via mobile computing device 102, a user to position a financial instrument (e.g., sample check 106) such that sample check 106 is aligned with virtual model 608. Mobile banking app 304 may instruct the user via user instructions 604, which may be depicted as positioned within physical environment 602. In particular, user instructions 604 may be depicted as positioned on surface 606.

In some embodiments, method 900 may further include determining an extent of alignment of sample check 106 with virtual model 608 based on an overlap of a field of virtual model 608 (e.g., virtual model address field 702), as depicted in physical environment 602, and a corresponding field of sample check 106 (e.g., address field 204) (as shown in FIG. 8). The UI may indicate overlap of a given field by, for example, changing color (e.g., turning green when sufficient overlap is determined). In some embodiments, method 900 may further include determining an extent of alignment of sample check 106 with virtual model 608 based on whether virtual model 608 as depicted within physical environment 602 overlays all corners of sample check 106.

Step 910 may include determining a distance (e.g., distance 810) from mobile computing device 102 to sample check 106 and an orientation of mobile computing device 102 relative to at least one of sample check 106 or surface 606 (the substantially level surface). The distance and the orientation may be a distance from camera 104 to sample check 106 and an orientation of sample check 106 and/or surface 606 relative to camera 104. In some embodiments, the distance may be a distance from camera 104 to a point within the center of field of view 108 of camera 104 that lies on sample check 106 or surface 606 (as shown in FIG. 8). In alternative embodiments, the distance may be a distance from camera 104 to any feature point of sample check 106. In alternative embodiments, the distance may be a distance from camera 104 to a center point of sample check 106. The distance and the orientation may be determined using any of the methods disclosed herein.

In some embodiments, the distance may be determined based on image data collected from the image stream, for example, using the image analysis methods described herein. In some embodiments, the orientation of mobile computing device 102 may be determined based on data received from a motion sensor within mobile computing device 102. The motion sensor may be any of onboard sensors 510 (e.g., an accelerometer, gyroscope, and/or magnetometer). In some embodiments, the motion sensor may be an IMU.

In some embodiments, the orientation of mobile computing device 102 relative to sample check 106 may include a tilt (e.g., a horizontal and/or vertical tilt) of mobile computing device 102 relative to sample check 106 and a skew of mobile computing device 102 relative to sample check 106.

In some embodiments, method 900 may further include instructing, via mobile computing device 102, the user to position mobile computing device 102 on a substantially level surface (e.g., surface 606); setting a baseline orientation based on an orientation of mobile computing device 102 relative to an external coordinate system (e.g., world coordinate system 802) when mobile computing device 102 is positioned on surface 606; and automatically capturing an image of sample check 106 based on an orientation of mobile computing device 102 corresponding to the baseline orientation.

In some embodiments, method 900 may further include displaying, on the display of mobile computing device 102, instructions (e.g., user instructions 604, which can be virtual instructions) to adjust at least one of the distance from mobile computing device 102 to the financial instrument or the orientation of mobile computing device 102, user instructions 604 being depicted as positioned within physical environment 602. In some embodiments, user instructions 604 may be depicted as positioned on surface 606 (the substantially level surface). In some embodiments, the user instructions 604 may include specific directions on how to adjust the positioning of mobile computing device 102. For example, the user instructions may include, “Tilt camera forward,” “Tilt camera backward,” “Tilt camera to the right,” “Tilt camera to the left,” “Rotate camera clockwise,” “Rotate camera counterclockwise,” “Move camera farther back,” “Move camera forward,” “Move camera up,” “Move camera down,” “Move camera to the right,” “Move camera to the left,” or any other spatial positioning instructions.

Step 912 may include automatically capturing an image of the financial instrument (e.g., sample check 106) based on the distance and the orientation of mobile computing device 102 relative to sample check 106 determined in step 910.

In some embodiments, method 900 may further include calculating a confidence score indicating a likelihood of accurately extracting data from the image of sample check 106 via OCR, the confidence score being based on the distance from mobile computing device 102 to sample check 106, the tilt of mobile computing device 102 relative to sample check 106, and the skew of mobile computing device 102 relative to sample check 106. In such embodiments, automatically capturing the image of sample check 106 may be further based on the confidence score exceeding a predetermined threshold.

While the above description has referenced automatic image capture as the result of proper distance and orientation of mobile computing device 102 relative to a financial instrument (e.g., sample check 106), this disclosure is not limited to automatic image capture (e.g., automatically capturing an image frame for storage in memory and later processing). For example, the conditions determined as described above using AR platform 310 may be used to indicate to a user that an image is ready to be captured, and mobile banking app 304 may prompt a user to capture an image manually using any known methods. The methods may include displaying an instruction or indication via user instructions 604. For example, mobile banking app 304 may change the color of a virtual object or a portion of the virtual object (e.g., virtual model 608 and/or user instructions 604) depicted as within physical environment 602 to indicate an image is ready to be captured.

Alternatively, or in addition to, a single image being automatically or manually captured, multiple images or partial images may be collected for OCR processing performed either on mobile computing device 102 or remotely (e.g., on cloud banking system 316), as described in U.S. patent application Ser. No. 18/503,787, filed Nov. 7, 2023 and titled “BURST IMAGE CAPTURE,” the disclosure of which is incorporated herein by reference in its entirety. In some embodiments, this may occur upon proper positioning achieved using the above systems and methods. Accordingly, techniques described in U.S. patent application Ser. No. 18/503,787 may be used to identify fields of sample check 106 when relative distance and orientation conditions are satisfied. In alternative embodiments, image collection and processing as described in U.S. patent application Ser. No. 18/503,787 may occur independently of proper positioning, but may be made more successful and efficient by AR remote check capture aid 600 guiding a user toward proper positioning while image collection and processing is performed.

Further, methods for active OCR of a financial instrument may be implemented in tandem with the AR functions described in the present disclosure. Active OCR includes performing OCR on a live image stream during a current customer transaction time period. For example, the active OCR process may be completed before finalization of a remote deposit operation. Active OCR of a financial instrument may employ image analysis features at client device 302 (e.g., mobile computing device 102) to extract text from a live image stream of the financial instrument and forward extracted data without capturing an image or image frame for later transmission to a backend system. Systems and methods for active OCR are disclosed in U.S. patent application Ser. No. 18/503,778, filed Nov. 7, 2023 and titled “ACTIVE OCR,” the disclosure of which is incorporated herein by reference in its entirety. Additionally, active OCR may be performed on multiple images or partial images that are ranked according to their quality, as described in U.S. patent application Ser. No. 18/503,787.

Accordingly, in some embodiments, the AR systems and methods described herein may be used to assist a user in properly positioning mobile computing device 102 relative to sample check 106, while active OCR methods described in U.S. patent application Ser. No. 18/503,778 and/or U.S. patent application Ser. No. 18/503,787 may be performed upon proper positioning or be facilitated by proper positioning achieved as described herein. Therefore, mobile banking app 304 may instruct a user to position mobile computing device 102 such that the conditions determined using AR platform 310, described above, are within the predetermined ranges and thresholds described above, whether or not an image is automatically captured and transmitted to a backend system.

In some embodiments, initial active OCR results may be combined with positioning conditions determined using AR platform 310 to even more accurately determine whether a captured image would be acceptable for further processing. Accordingly, the confidence score discussed above may further be based on active OCR results (e.g., an amount or percentage of text successfully identified and extracted from sample check 106).

The solutions described above provide technical solutions to shortcomings of current remote deposit image capture processes. The various aspects solve at least the technical problems associated with determining, prior to image capture, whether an image of a financial instrument to be captured will be able to be processed to extract data necessary for execution of a transaction, resulting in a more efficient remote deposit process and user experience. The various embodiments and aspects described by the technology disclosed herein are able to provide precise positioning determinations and instructions mid-image capture experience, before the customer completes the transaction, to avoid requiring the customer to provide additional new image captures post image quality or OCR failures. The various embodiments and aspects described herein also aid the user, particularly inexperienced users, with easily and accurately performing remote deposit capture while reducing or eliminating the need to recapture check images, which is a technical shortcoming and user pain-point of existing systems.

### Example Computer System

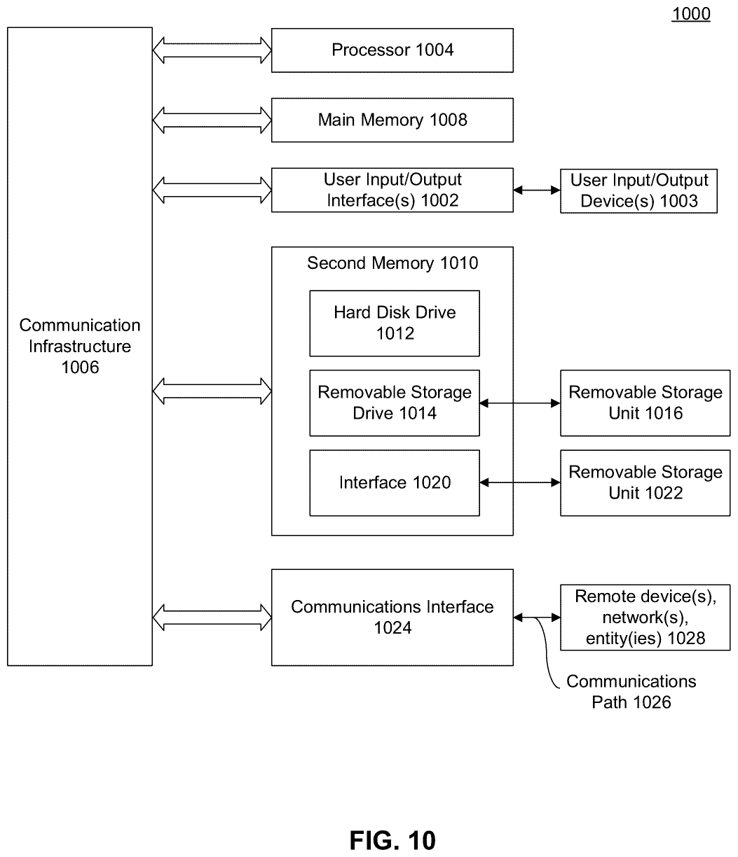

FIG. 10 depicts an example computer system useful for implementing various embodiments.

Various embodiments may be implemented, for example, using one or more well-known computer systems, such as computer system 1000 shown in FIG. 10. One or more computer systems 1000 may be used, for example, to implement any of the embodiments discussed herein, as well as combinations and sub-combinations thereof. For example, the example computer system may be implemented as part of mobile computing device 102, client device 302, cloud banking system 316, etc. Cloud implementations may include one or more of the example computer systems operating locally or distributed across one or more server sites.

Computer system 1000 may include one or more processors (also called central processing units, or CPUs), such as a processor 1004. Processor 1004 may be connected to a communication infrastructure or bus 1006.

Computer system 1000 may also include customer input/output device(s) 1002, such as monitors, keyboards, pointing devices, etc., which may communicate with communication infrastructure 1006 through customer input/output interface(s) 1002.

One or more of processors 1004 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1000 may also include a main or primary memory 1008, such as random access memory (RAM). Main memory 1008 may include one or more levels of cache. Main memory 1008 may have stored therein control logic (i.e., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1016. Removable storage unit 1016 may include a computer usable or readable storage device having stored thereon computer software (control logic) and/or data. Removable storage unit 1016 may be a floppy disk, magnetic tape, compact disk, DVD, optical storage disk, and/any other computer data storage device. Removable storage drive 1014 may read from and/or write to removable storage unit 1016.

Secondary memory 1010 may include other means, devices, components, instrumentalities or other approaches for allowing computer programs and/or other instructions and/or data to be accessed by computer system 1000. Such means, devices, components, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1000 may further include a communication or network interface 1024. Communication interface 1024 may enable computer system 1000 to communicate and interact with any combination of external devices, external networks, external entities, etc. (individually and collectively referenced by reference number 1028). For example, communication interface 1024 may allow computer system 1000 to communicate with external or remote devices 1028 over communications path 1026, which may be wired and/or wireless (or a combination thereof), and which may include any combination of LANs, WANs, the Internet, etc. Control logic and/or data may be transmitted to and from computer system 1000 via communication path 1026.

Computer system 1000 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1000 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1000 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML Customer Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1000, main memory 1008, secondary memory 1010, and removable storage units 1016 and 1022, as well as tangible articles of manufacture embodying any combination of the foregoing. Such control logic, when executed by one or more data processing devices (such as computer system 1000), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 9. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

What is claimed is:

1. A computer-implemented method for a remote deposit environment, comprising:
identifying, by a mobile device, a substantially level surface within a field of view of a camera of the mobile device;
displaying, on a display of the mobile device, an image stream of a physical environment including the substantially level surface;
displaying, on the display of the mobile device, a virtual model of a financial instrument, the virtual model of the financial instrument depicted as having a position and orientation relative to the substantially level surface;
instructing, via the mobile device, a user to position a financial instrument such that the financial instrument is aligned with the virtual model;
determining a distance from the mobile device to the financial instrument and an orientation of the mobile device relative to at least one of the financial instrument or the substantially level surface;
based on the distance and the orientation of the mobile device, automatically capturing an image of the financial instrument.

2. The method of claim 1, wherein the orientation of the mobile device is determined based on data received from a motion sensor within the mobile device.

3. The method of claim 2, wherein the distance is determined based on image data collected from the image stream.

4. The method of claim 2, wherein the orientation of the mobile device comprises a tilt of the mobile device relative to the financial instrument and a skew of the mobile device relative to the financial instrument.

5. The method of claim 4, further comprising:
calculating a confidence score indicating a likelihood of accurately extracting data from the image of the financial instrument via optical character recognition (OCR), wherein the confidence score is based on the distance, the tilt, and the skew, wherein the automatically capturing the image of the financial instrument is further based on the confidence score exceeding a predetermined threshold.

6. The method of claim 1, wherein the virtual model comprises a plurality of fields configured to be aligned with corresponding fields of the financial instrument.

7. The method of claim 6, further comprising determining an extent of alignment of the financial instrument with the virtual model based on an overlap of a field of the virtual model, as depicted in the physical environment, and a corresponding field of the financial instrument.

8. The method of claim 1, further comprising determining an extent of alignment of the financial instrument with the virtual model based on whether the virtual model as depicted within the physical environment overlays all corners of the financial instrument.

9. The method of claim 1, wherein the position of the virtual model is selected, at the mobile device, based on a lighting condition in the physical environment.

10. The method of claim 1, wherein the position of the virtual model is selected, at the mobile device, based on a position of another object within the physical environment.

11. The method of claim 1, wherein the orientation of the virtual model may be manipulated by the user based on a user gesture.

12. The method of claim 11, further comprising instructing, via the mobile device, the user to turn over the virtual model.

13. The method of claim 1, further comprising:
instructing, via the mobile device, the user to position the mobile device on the substantially level surface;
setting a baseline orientation based on an orientation of the mobile device relative to an external coordinate system when the mobile device is positioned on the substantially level surface;
automatically capturing the image of the financial instrument based on an orientation of the mobile device corresponding to the baseline orientation.

14. The method of claim 1, wherein the virtual model is selectable by the user among a plurality of virtual models of financial instruments.

15. The method of claim 1, further comprising displaying, on the display of the mobile device, an updated virtual model, wherein the updated virtual model is updated based on previous images of financial instruments associated with an account of the user.

16. The method of claim 15, wherein the virtual model is updated using a trained machine learning (ML) model.

17. The method of claim 1, further comprising displaying, on the display of the mobile device, virtual instructions to adjust at least one of the distance from the mobile device to the financial instrument or the orientation of the mobile device, the virtual instructions depicted as positioned within the physical environment.

18. The method of claim 17, wherein the virtual instructions are depicted as positioned on the substantially level surface.

19. A system, comprising:
a memory; and
at least one processor coupled to the memory and configured to:
identify, by a mobile device, a substantially level surface within a field of view of a camera of the mobile device;
display, on a display of the mobile device, an image stream of a physical environment including the substantially level surface;
display, on the display of the mobile device, a virtual model of a financial instrument, the virtual model of the financial instrument depicted as having a position and orientation relative to the substantially level surface;
instruct, via the mobile device, a user to position a financial instrument such that the financial instrument is aligned with the virtual model;
determining a distance from the mobile device to the financial instrument and an orientation of the mobile device relative to at least one of the financial instrument or the substantially level surface;
based on the distance and the orientation of the mobile device, automatically capture an image of the financial instrument.

20. A non-transitory computer-readable device having instructions stored thereon that, when executed by at least one computing device, causes the at least one computing device to perform operations comprising:
identifying, by a mobile device, a substantially level surface within a field of view of a camera of the mobile device;
displaying, on a display of the mobile device, an image stream of a physical environment including the substantially level surface;
displaying, on the display of the mobile device, a virtual model of a financial instrument, the virtual model of the financial instrument depicted as having a position and orientation relative to the substantially level surface;
instructing, via the mobile device, a user to position a financial instrument such that the financial instrument is aligned with the virtual model;
determining a distance from the mobile device to the financial instrument and an orientation of the mobile device relative to at least one of the financial instrument or the substantially level surface;
based on the distance and the orientation of the mobile device, automatically capturing an image of the financial instrument.
